(19) United States
(12) Patent Application Publication
(10) Pub. No.: US 2025/0249516 A1
(43) Pub. Date: Aug. 7, 2025

(54) LATHE, LATHE MACHINING SYSTEM, AND METHOD OF ESTIMATING NOSE POSITION IN LATHE

(71) Applicant: Yamazaki Mazak Corporation, Niwa-gun (JP)

(72) Inventors: Kenji FUKUTA, Niwa-gun (JP); Youji TAMURA, Niwa-gun (JP)

(73) Assignee: Yamazaki Mazak Corporation, Niwa-gun (JP)

(21) Appl. No.: 19/188,001

(22) Filed: Apr. 24, 2025

Related U.S. Application Data
(63) Continuation of application No. PCT/JP2023/002668, filed on Jan. 27, 2023.

(51) Int. Cl. B23B 29/32; B23B 3/16

(52) U.S. Cl. CPC B23B 29/32; B23B 3/16; B23B 2270/48

(57) ABSTRACT

A lathe includes a tool holder having a holder reference point, and a tool having a tool nose is attachable to the tool holder. A tool post has a tool post origin and mounting surfaces. An actuator is to adjust each of the mounting surfaces to an indexing position. A memory stores first distances between the tool post origin and the holder reference point of the tool holder mounted on the mounting surfaces, respectively. The memory stores instructions that when executed by a processor, cause the processor to perform operations. The operations include obtaining a second distance between the holder reference point and the tool nose of the attached tool, and estimating, based on the first distances and second distance, a third distance between the tool post origin and the tool nose of the attached tool to control the actuator.

### CROSS-REFERENCE TO RELATED APPLICATIONS

The present application is a continuation application of International Application No. PCT/JP2023/002668, filed Jan. 27, 2023. The contents of this application are incorporated herein by reference in their entirety.

### BACKGROUND OF THE INVENTION

### Field of the Invention

The present invention relates to a lathe, a lathe machining system, and a method of estimating a nose position in a lathe.

### Discussion of the Background

JP3648054B and JP2010-280028A disclose techniques associated with estimating a position of a nose of a machine tool. JP3648054B discloses a technique that includes measuring a position misalignment between a nose position at which a tool is directly attached to a tool spindle and a nose position at which a tool is attached to the tool spindle via an attachment. The technique also includes storing the position misalignment. JP2010-280028A discloses a mathematical model that obtains a position misalignment of nose position in a case that an angle head, which is an attachment, is used. The position misalignment is obtained based on a position misalignment parameter of the angle head and a dimension parameter of a tool. In these machine tools, the orientation of the tool can be adjusted by replacing the attachment.

In contrast, there are machine tools that eliminate the need for replacing attachments in the manners recited in JP3648054B and JP2010-280028A. Specifically, in a state in which a plurality of tools are mounted on a plurality of respective mounting surfaces of a tool post, the mounting surface for a tool used for machining is moved to replace attachments. JP2022-035083A discloses an example of such machine tool. Specifically, JP2022-035083A discloses a turret lathe. JP2016-036868A discloses another example of such machine tool. Specifically, JP2016-036868A discloses a tool post with a plurality of tools arranged in a comb-shaped configuration.

### SUMMARY OF THE INVENTION

According to one aspect of the present invention, a lathe includes a tool holder, a tool post, an actuator, a processor, and a memory. The tool holder has a holder reference point, and a tool having a tool nose is attachable to the tool holder. The tool post has a tool post origin and has mounting surfaces on which the tool holder is mountable. The actuator is configured to move the tool post to adjust each of the mounting surfaces to an indexing position. The processor is configured to control the actuator. The memory stores first distances in a first direction between the tool post origin and the holder reference point of the tool holder mounted on the mounting surfaces, respectively, an attached tool being attached to the tool holder, one of the mounting surfaces on which the tool holder is mounted being a mounted surface, the mounted surface being adjusted to the indexing position. The memory stores instructions that when executed by the processor, cause the processor to perform operations. The operations include obtaining an identifier of the attached tool. The operations include obtaining, from a storage, a second distance in the first direction between the holder reference point and the tool nose of the attached tool with the mounted surface being adjusted to the indexing position, the identifier of the attached tool corresponding to an identifier of one of candidate tools, the storage storing first correlation between identifiers of the candidate tools and the second distances between the holder reference point and tool noses of the candidate tools, respectively. The operations include estimating, based on the first distances, the mounted surface, and the second distance that has been obtained, estimate a third distance in the first direction between the tool post origin and the tool nose of the attached tool to control the actuator based on the third distance.

According to another aspect of the present invention, a lathe machining system includes the above-described lathe, a tool presetter, a network, and the storage. The tool presetter is configured to obtain an identifier of the tool and to measure the second distance for a measured tool identified by the identifier of the tool that has been obtained in a state in which the measured tool is removed from the tool holder. The processor is configured to communicate with the tool presetter via the network. The storage is connected to the network. The storage is configured to store the first correlation such that the first correlation correlates the identifier of the measured tool with data indicating the second distance that has been measured. The processor is configured to obtain the second distance corresponding to the identifier of the measured tool that is identical to the identifier of the attached tool.

According to further aspect of the present invention, a method of estimating a nose position in a lathe includes preparing a tool holder which has a holder reference point and to which a tool having a tool nose is attachable, and preparing a tool post having a tool post origin and having a plurality of mounting surfaces. The method includes mounting the tool holder on a mounted surface among the plurality of mounting surfaces, and attaching, to the tool holder, a measurement tool having a measurement target. The method includes moving the tool post to adjust the mounted surface to an indexing position, and measuring a distance in a first direction between the measurement target and the tool post origin. The method includes obtaining a seventh distance in the first direction between the holder reference point and the measurement target with the measurement tool being attached to the tool holder, the mounted surface being adjusted to the indexing position. The method includes, based on the measured distance and the seventh distance, obtaining a first distance in the first direction between the tool post origin and the holder reference point to store the first distance. The method includes obtaining an identifier of a measured tool, measuring a second distance in the first direction between the holder reference point and the tool nose of the measured tool when the measured tool is attached to the tool holder and the mounted surface is adjusted to the indexing position. The method includes storing first correlation that correlates the identifier of the measured tool with the second distance and attaching an attached tool to the tool holder to adjust the mounted surface to the indexing position. The method includes obtaining an identifier of the attached tool. The method includes obtaining the second distance corresponding to the identifier of the measured tool that is identical to the identifier of the attached tool, and estimating a third distance in the first direction between the tool post origin and the tool nose of the attached tool based on the second distance that has been obtained and the first distance.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates a schematic configuration of a lathe machining system according to a first embodiment;

FIG. 2 is an enlarged view of a turret;

FIG. 3 illustrates an example of a tool holder mounted on the turret and an example of a tool attached to the tool holder;

FIG. 4 illustrates an example of a tool post on which the tool holder is mounted;

FIG. 5 illustrates a state in which the tool is inserted in the tool holder;

FIG. 6 illustrates an example of the tool as seen from a direction along a tool center axis;

FIG. 7 is a block diagram of a hardware configuration of the lathe machining system according to the first embodiment;

FIG. 8 illustrates a schematic configuration of a tool attachment part of a tool presetter;

FIG. 9 is a schematic illustration of tool dimensions, tool holder dimensions, and tool post dimensions according to the first embodiment;

FIG. 10 illustrates an example of tool data;

FIG. 11 illustrates an example of mounting surface data according to the first embodiment;

FIG. 12 is a schematic illustration of a method of measuring a holder reference point of the tool holder;

FIG. 13 is a flowchart of processing in a method of estimating a nose position in a lathe;

FIG. 14 illustrates a schematic configuration of a lathe according to a second embodiment;

FIG. 15 is a block diagram of a hardware configuration of a lathe machining system according to the second embodiment;

FIG. 16 is a schematic illustration of tool dimensions, tool holder dimensions, and tool post dimensions according to the second embodiment; and

FIG. 17 illustrates an example of mounting surface data according to the second embodiment.

### DESCRIPTION OF THE EMBODIMENTS

Embodiments will now be described with reference to the accompanying drawings, wherein like reference numerals designate corresponding or identical elements throughout the various drawings.

### First Embodiment

### Configuration of Lathe 1

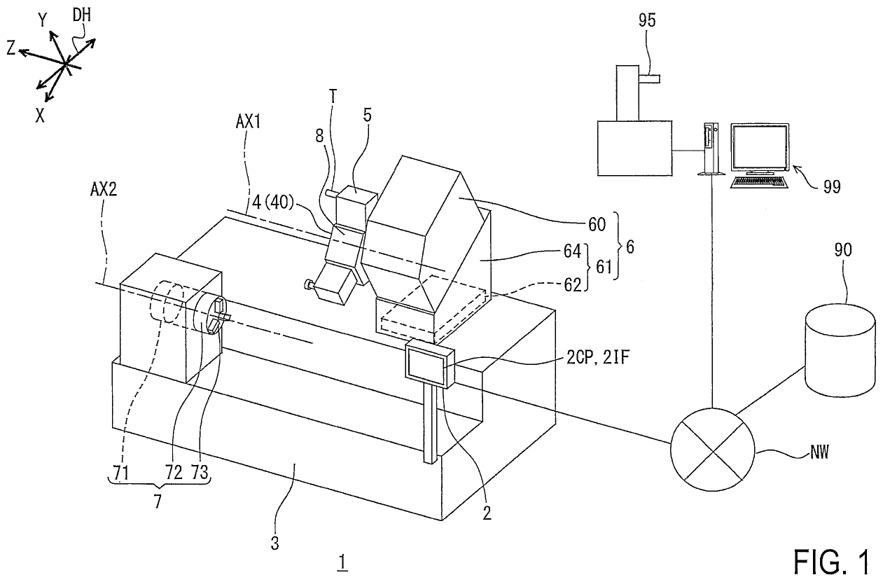

FIG. 1 illustrates a schematic configuration of a lathe machining system 100. The lathe machining system 100 includes a lathe 1 according to the first embodiment of the present disclosure. As used herein, the term “lathe” is intended to mean a machine tool primarily used for rotating a workpiece to perform operations such as external turning, boring, parting, facing, and threading using tools such as a cutting bit. The lathe machining system 100 includes the lathe 1, a network NW, a computer 99, a tool presetter 95, and a storage 90. The storage 90 is connected to the network NW. The network NW connects the computer 99 and the lathe 1 to each other to enables the lathe 1 and the tool presetter 95 to communicate with each other. The computer 99 may be a general-purpose computer that includes electronic circuits such as a hardware processor and memory. The tool presetter 95 is similar to, for example, the device disclosed in JP-H-3-66552A, and is a device that measures dimensions of a tool attached to a turret. The computer 99 controls the tool presetter 95 to measure the dimensions of the measured tool and transmit the obtained dimension data to the lathe 1. The network NW may be either a wired network such as an intranet or a wireless network such as a wireless LAN. In this embodiment, the storage 90 is a network storage provided on the network NW. This network storage may, for example, be a cloud-based storage. The storage 90 may be a memory within the computer 99 or a memory within a machine control unit 2, described later.

In this embodiment, the lathe 1 is a numerically controlled lathe configured as a turret lathe. As used herein, the term “numerically controlled lathe” is intended to mean a lathe that controls relative movement between a cutting tool and a workpiece based on numerical data such as position and speed, and performs a series of machining operations through programmed commands. The lathe 1 includes the machine control unit 2, a base 3. a tool post 4, a tool holder 5, an actuator 6, and a workpiece holder 7. In this embodiment, the tool post 4 is a turret 40. The turret 40 has a plurality of mounting surfaces 8. The actuator 6 includes a swivel driver 60 and a translation (linear) driver 61. The swivel driver 60 causes the turret 40 to rotate about a first axis AX1. The translation driver 61 causes the turret 40 to move on the base 3. It is to be noted that the translation driver 61 may be omitted. The first axis AX1 extends along Z axis of the three-dimensional orthogonal coordinate system illustrated in FIG. 1. An example of the swivel driver 60 is a motor. The swivel driver 60 positions the turret 40 to a predetermined angular position about the first axis AX1. For this purpose, in a case that the swivel driver 60 is either a stepper motor capable of controlling the rotational position using feedforward control or a servo motor, the swivel driver 60 preferably includes a rotational position detection sensor, such as an encoder, to position the turret 40 to a predetermined angular position about the first axis AX1.

The translation driver 61 includes a first driver 62 and a second driver 64. The first driver 62 is configured to move the tool post 4 in a Z axis direction. The second driver 64 is configured to move the tool post 4 in an X axis direction of the three-dimensional orthogonal coordinate system illustrated in FIG. 1. The X axis direction is perpendicular to the Z axis direction and crosses a horizontal direction DH. A Y axis direction in the three-dimensional orthogonal coordinate system is a direction perpendicular to the X axis direction and the Z axis direction. The X axis direction is a direction in which a tool T attached to the turret 40 is caused to translate when a workpiece is machined. In this embodiment, the X axis direction is 30 degrees inclined relative to a vertical direction. The orientation of the X axis direction varies depending on the structure of the lathe 1. The translation driver 61 (the first driver 62, the second driver 64) is made up of, for example, a motor and a ball screw. The translation driver 61 configured to determine the rotation position of the motor for the positioning of the tool post 4. For this purpose, the motor is preferably a stepper motor, or the translation driver 61 preferably includes a rotational position detection sensor, such as an encoder. To ensure a concise description, the translation driver 61 is not configured to move the tool post 4 in the Y axis direction. The translation driver 61, however, may further include a driver to move the tool post 4 in the Y axis direction.

The workpiece holder 7 includes a jaw 73, a chuck 72, and a swivel driver 71. The jaw 73 holds a workpiece. On the chuck 72, the jaw 73 is mounted. The swivel driver 71 causes the chuck 72 to rotate about a second axis AX2. The workpiece holder 7 may further include a driver with a function and a configuration that are similar to the function and the configuration of the first driver 62, which causes a movement in the Z axis direction. It is to be noted that the second axis AX2 is parallel to the first axis AX1. That is, the second axis AX2 extends along the Z axis of the three-dimensional orthogonal coordinate system. That is, the workpiece holder 7 is configured to hold the workpiece rotatably about the workpiece rotation axis (the second axis AX2). The X axis direction is a direction perpendicular to the first axis AX1 and the second axis AX2 and corresponding to a cutting direction in which the workpiece is cut. The swivel driver 71 is configured to control the rotational speed of the chuck 72. The machine control unit 2 is configured to control the actuator 6 (the swivel driver 60 and the translation driver 61).

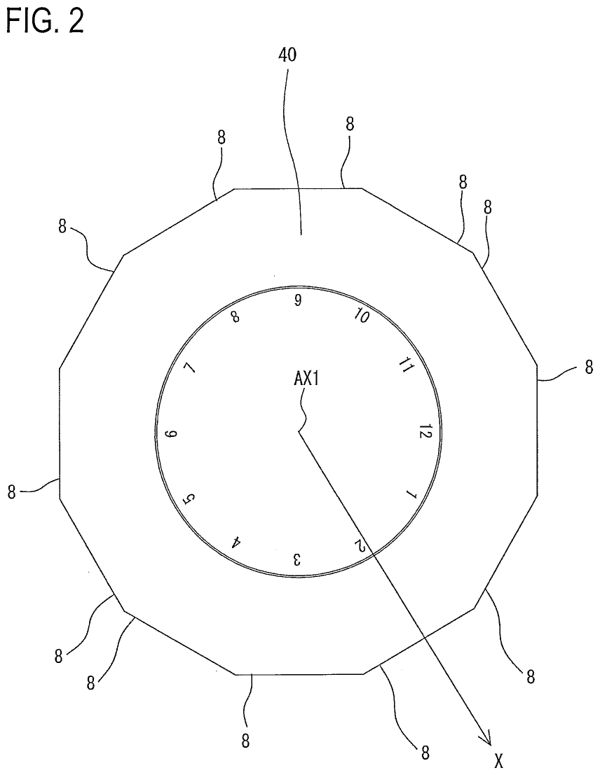

FIG. 2 is an enlarged view of the turret 40. Referring to FIG. 2, which is a view of the turret 40 as seen from a direction along the first axis AX1, the outer shape of the turret 40 is a substantially regular polygon centered around the first axis AX1. Each of the plurality of mounting surfaces 8 corresponds to one side of the regular polygon. As illustrated in FIG. 2, each of the plurality of mounting surfaces 8 is assigned a number. This number will be referred to as station number. In the example illustrated in FIG. 2, the plurality of mounting surfaces 8 are 12 surfaces, that is, the outer shape of the turret 40 is a regular dodecagon. In the following description of the embodiment, the position of a mounting surface, among the plurality of mounting surfaces 8, that is located along the X axis direction from the first axis AX1 will be referred to as indexing position. Each T code in a machining program includes a number corresponding to a station number. The turret 40 is rotated to position, to the indexing position, a mounting surface 8 with a station number corresponding to the number included in each T code. That is, the actuator 6 (the swivel driver 60) is configured to move the tool post 4 to position each mounting surface of the plurality of mounting surfaces 8 to the indexing position.

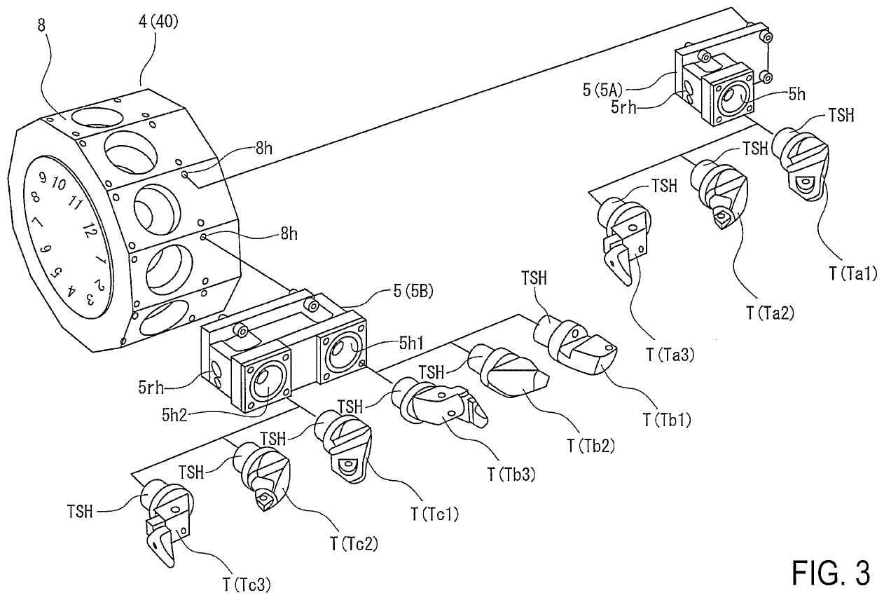

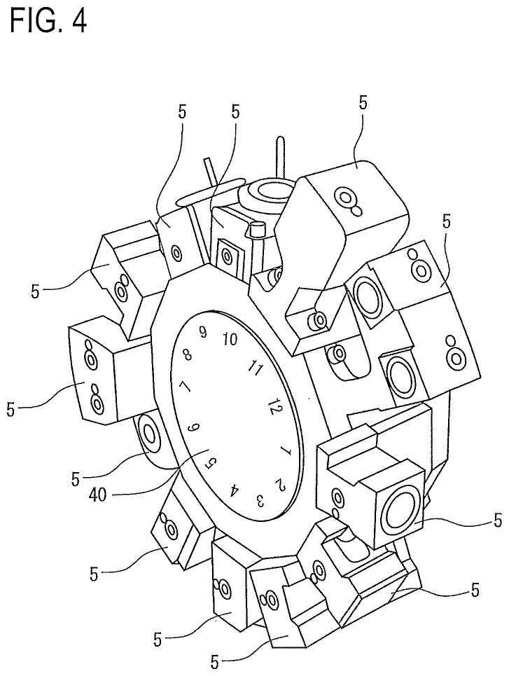

To the tool holder 5, the tool T is attachable. FIG. 3 illustrates an example of the tool holder 5 mounted on the turret 40 and an example of the tool T attached to the tool holder 5. Each of the plurality of mounting surfaces 8 has a plurality of mounting holes 8h for various tool holders 5 to be mounted on the each mounting surface 8. Thus, the tool holder 5 can be mounted on each of the plurality of mounting surfaces 8. Each of the plurality of mounting holes 8h may have a hole threaded to engage with a bolt to mount the tool holder 5, and may have a hole for inserting a pin for the positioning of the tool holder 5. Thus, the tool holder 5 can be mounted on each mounting surface 8 of the turret 40 so that the tool holder 5 can be mounted on all the mounting surfaces 8 of the turret 40 as illustrated in FIG. 4. It is to be noted, however, that the tool holder 5 may not necessarily be mounted on at least one mounting surface 8.

The tool holder 5 is a device that can be mountable on each of the plurality of mounting surfaces 8 and that is capable of attaching the tool T to the tool holder 5 reproducibly. As used herein, the term “reproducibly” in the context of attaching the tool T to the tool holder 5 is intended to mean that the misalignment in the nose position, occurring when the same tool T is mounted multiple times, is so small (for example, on the order of a few to several micrometers) that it is negligible during machining operations. The tool holder 5 is either a single holder 5A or a double holder 5B. The single holder 5A is capable of holding a single the tool T. The double holder 5B is capable of holding a plurality of tools T. The single holder 5A has an insertion hole 5h. In the insertion hole 5h, a tool shaft TSH of the tool T is inserted. The double holder 5B has insertion holes 5h1 and 5h2. In the insertion holes 5h1 and 5h2, the tool shaft TSH of the tool T is inserted. The insertion holes 5h, 5h1, and 5h2 are substantially identical in shape to each other so that various tools T (Ta1 to Ta3, Tb1 to Tb3, Tc1 to Tc3) can be attached to the tool holder 5. The tool shafts TSH of the tools T (Tal to Ta3, Tb1 to Tb3, Tc1 to Tc3) are substantially identical in shape to each other.

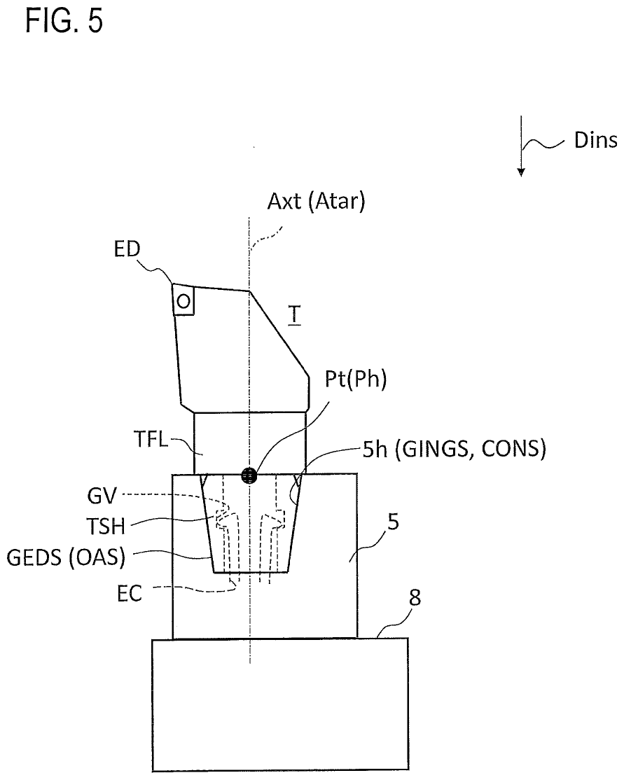

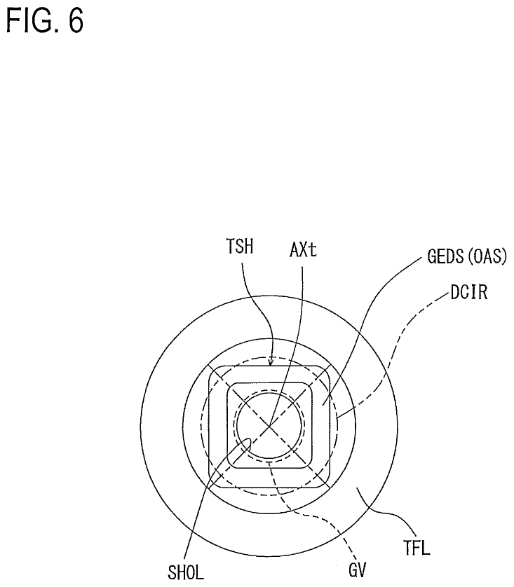

Next, a description will be made with regard to a structure of the tool holder 5, which is capable of holding the tool T reproducibly. FIG. 5 illustrates a state in which the tool T is inserted in the tool holder 5. The tool T includes the tool shaft TSH, a tool flange TFL, a tool center axis Axt, and a nose ED. The tool flange TFL is formed at one end of the tool shaft TSH. The tool center axis Axt is a center axis of the tool shaft TSH. The nose ED contacts a workpiece during machining of the workpiece. It is to be noted that the tool T may be regarded as being made up of a head having the nose ED and an adapter having the tool shaft TSH and that an adapter-equipped head may be regarded as the tool T. FIG. 6 illustrates an example of the tool T as seen from a direction along the tool center axis Axt. FIG. 6 illustrates the other end of the tool shaft TSH opposite to the tool flange TFL. It is to be noted that FIGS. 5 and 6 illustrate an example structure necessary for holding the tool T reproducibly and that there may be any other shapes capable of holding the tool T reproducibly. Specific examples of this shape include, for example, shapes compliant with ISO26623-1 standard, ISO12164 standard, and ISO26623-1 standard. Side surfaces of the tool shaft TSH form a tapered shape that extends along the tool center axis Axt and gradually approaches the tool center axis Axt in a direction away from the tool flange TFL. The side surfaces will be collectively referred to as guided surface GEDS.

The insertion hole 5h has a side surface shape that fits the guided surface GEDS of the tool shaft TSH. Side surface of the insertion hole 5h will be collectively referred to as guide surface GINGS. That is, the insertion hole 5h has a target center axis Atar. The target center axis Atar is equidistant from each guide surface GINGS of the insertion hole 5h.

Due to this nature of the shape of the guide surface GINGS, when the tool shaft TSH is inserted fully into the insertion hole 5h, the tool center axis Axt becomes substantially coaxial with the target center axis Atar. Specifically, the guide surface GINGS extends along the target center axis Atar and gradually approaches the target center axis Atar in an insertion direction Dins, which extends from the tool T toward the tool holder 5. The guided surface GEDS is guided by the guide surface GINGS.

Referring to FIG. 6, the tool T (the tool shaft TSH) has at least two posture adjustment surfaces OAS (in the example illustrated in FIG. 6, the at least two posture adjustment surfaces OAS correspond to the guided surface GEDS, which constitutes the four side surfaces of an approximately regular truncated square pyramid shape). The at least two posture adjustment surfaces OAS cross a circumferential direction DCIR, which is centered around the tool center axis Axt. The tool holder 5 has at least two contact surfaces CONS (the guide surface GINGS of the insertion hole 5h). The at least two contact surfaces CONS contact the at least two posture adjustment surfaces OAS. By this configuration, the posture of the tool T around the target center axis Atar is determined.

Referring to FIGS. 5 and 6, the tool holder 5 includes a jaw EC. The tool T (the tool shaft TSH) includes a shaft hole SHOL and an engagement groove GV. The jaw EC is inserted into the shaft hole SHOL. The jaw EC is engageable with and disengageable from the engagement groove GV by a jaw slide mechanism, not illustrated. When the jaw EC is engaged with the engagement groove GV, the tool T is unable to move in a direction along the target center axis Atar relative to the tool holder 5. Thus, the jaw EC is fixed to the tool holder 5. With this configuration, the tool holder 5 is capable of holding the tool T reproducibly.

It is to be noted, however, that whether the tool T includes the guided surface GEDS or the tool holder 5 includes the guide surface GINGS, whether the tool T includes the engagement groove GV or the tool holder 5 includes the jaw EC, whether the tool T includes the at least two posture adjustment surfaces OAS or the tool holder 5 includes the at least two contact surfaces CONS can be freely determined through design modifications. In either case, the tool holder 5 is capable of holding the tool T reproducibly.

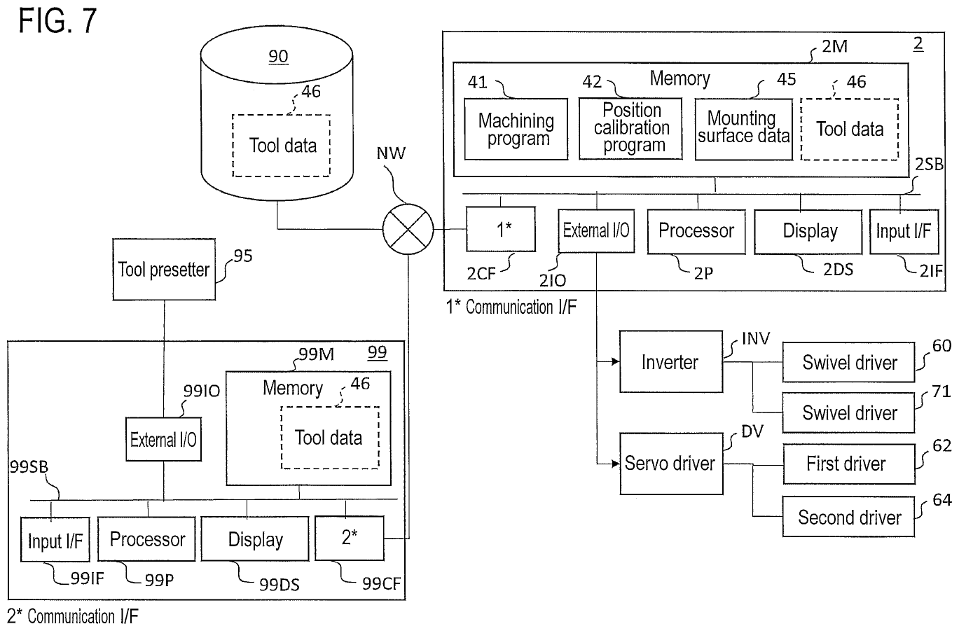

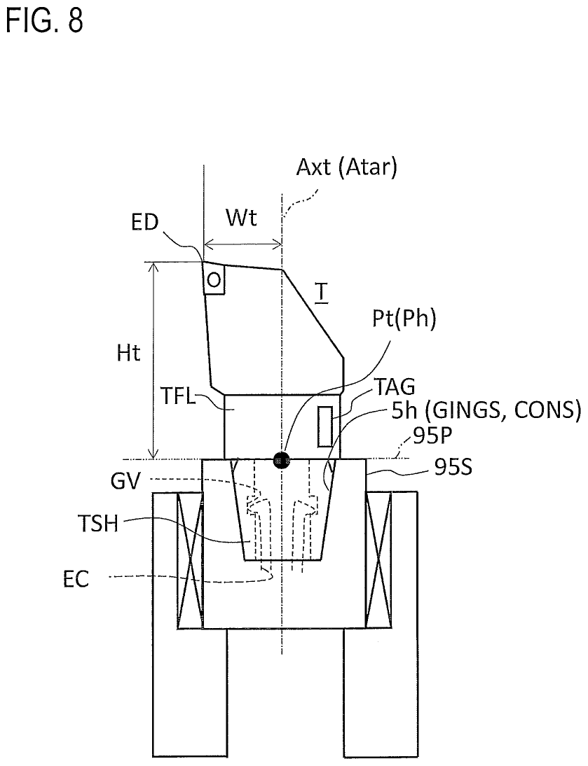

FIG. 7 is a block diagram of a hardware configuration of the lathe machining system 100 according to the first embodiment. The tool presetter 95 obtains an identifier (tool ID) of the tool T and measures distances in a plurality of directions between a holder reference point Ph (described later) and the position of the nose of the tool T. The tool presetter 95 is a device similar to the device disclosed in JP-H-3-66552A, as described above. Additionally, by applying the present invention, the tool presetter 95 has the following features. FIG. 8 illustrates a schematic configuration of a tool attachment part of the tool presetter 95. In the example illustrated in FIG. 8, the tool presetter 95 includes the guide surface GINGS, which is substantially identical to the guide surface GINGS of the tool holder 5, the at least two contact surfaces CONS, and a spindle 95S. The spindle 95S has the structure of the jaw EC. The spindle 95S is rotatable by a rotation device, not illustrated (such as a gear, a handle, or a motor), to point the nose ED in any direction. The holder reference point Ph is a point determined by the guide surface GINGS, the at least two contact surfaces CONS, the jaw EC, and the shape of the engagement groove GV of the tool T. For example, the holder reference point Ph is the intersection between the rotation axis of the spindle 95S (coaxial with the target center axis Atar) and a reference surface 95P of the spindle 95S. The reference surface 95P contacts the tool flange TFL of the tool T. It is to be noted that an internal point of the tool T that is substantially identical to the holder reference point Ph when the tool T is attached to the spindle 95S will be referred to as tool reference point Ph. The position of the holder reference point Ph (tool reference point Pt) in FIG. 8 is illustrated for exemplary purposes only; the holder reference point Ph (tool reference point Pt) may be located at any other position insofar as the holder reference point Ph (tool reference point Pt) is common to all the tools T attachable to the tool holder 5 and the spindle 95S and identifiable by the tool presetter 95 and insofar as the holder reference point Ph (tool reference point Pt) is reproducibly located at the same position when any tool T is attached to the tool holder 5 and the spindle 95S. While in this embodiment the tool presetter 95 is used to measure the position of the tool nose, it is possible to use other means to measure the position of the tool nose. In this case, the holder reference point Ph (tool reference point Pt) may be located at any other position insofar as the holder reference point Ph (tool reference point Pt) is reproducibly located at the same position when any tool T is attached to the tool holder 5.

As illustrated in FIG. 8, the tool T has a tag TAG. The tag TAG has an identifier (tool ID) of the tool T. An example of the tag TAG is a bar code. Another example of the tag TAG is an RF-ID. When the tool T is attached to the spindle 95S, the tool presetter 95 reads the tool ID from the tag TAG to measure a length Ht and a length Wt. The length Ht and the length Wt indicate a positional relationship between the holder reference point Ph (the tool reference point Pt) and the nose ED. The tool presetter 95 includes a known tag reader to read the tool ID from the tag TAG. For example, in a case that the tag TAG is a bar code, the tool presetter 95 includes a bar code reader. In a case that the tag TAG is an RF-ID, the tool presetter 95 includes an RF-ID reader.

The computer 99 includes a hardware processor 99P, a memory 99M, a display 99DS, an input interface 99IF, a system bus 99SB, an external I/O interface 99IO, and a communication interface 99CF. The tool presetter 95 is connected to the computer 99 via the external I/O interface 99IO, such as an RS-232C device, a USB, and a local area network (LAN). The computer 99 is connected to the network NW via the communication interface 99CF. By using these configurations and by executing a known control program for the tool presetter 95 and a data transmission and reception program, the computer 99 obtains, from the tool presetter 95, the measured dimensions of the measured tool and the identifier of the measured tool, and transmits the obtained data to the storage 90. The storage 90 stores the dimensions of the measured tool and the identifier of the measured tool in a manner in which the dimensions of the measured tool are correlated with the identifier of the measured tool. Tool data 46 illustrated in FIG. 7 is data that correlates the dimensions of the measured tool with the identifier of the measured tool.

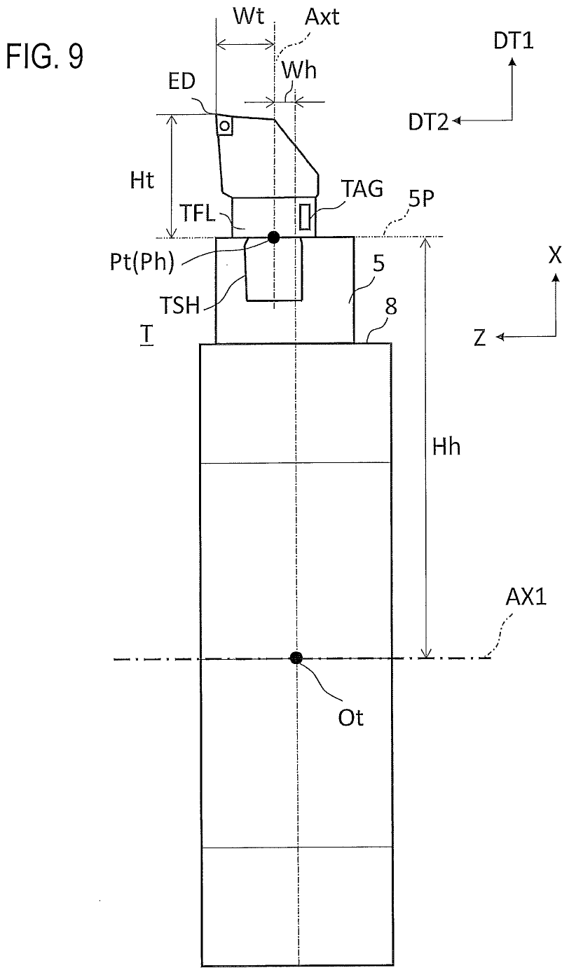

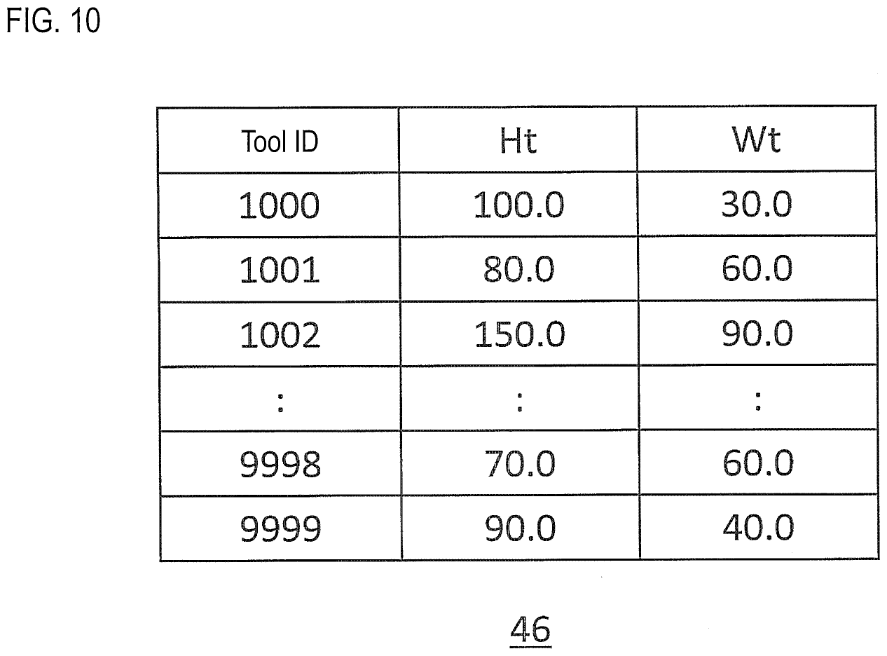

FIG. 9 is a schematic illustration of tool dimensions, tool holder dimensions, and tool post dimensions according to the first embodiment. FIG. 10 illustrates an example of the tool data 46. As illustrated in FIG. 9, the tool holder 5 includes the guide surface GINGS, which is substantially identical to the spindle 95S, the at least two contact surfaces CONS, and the structure of the jaw EC. Because of these shapes, the tool holder 5 has the holder reference point Ph, which corresponds to these shapes. The length Ht and the length Wt, which indicate the positional relationship between the holder reference point Ph (the tool reference point Pt) and the nose ED when the tool T is attached to the tool holder 5, are identical to a measurement result obtained by the tool presetter 95. The length Ht is a distance between the tool reference point Pt and the nose ED in a direction DT1, which extends along the tool center axis Axt. The length Wt is a distance between the tool reference point Pt and the nose ED in a direction DT2, which is a radial direction relative to the tool center axis Axt.

Referring to FIG. 10, the tool data 46 includes a correlation between the identifier (tool ID) of the tool T, the length Ht, and the length Wt. The tool T defined in the tool data 46 may be referred to as measured tool or candidate tool. While in FIG. 10 the correlation is expressed in table form, the tool data 46 may be expressed in any other form insofar as the tool data 46 has a data structure that can describe the correlation. Other examples of the data structure include a list, an array, and a database.

The machine control unit 2 includes an electronic circuit such as an electric control unit, a hardware processor 2P, a memory 2M, and a system bus 2SB. The hardware processor 2P is information processing means. The memory 2M is storing means. The system bus 2SB connects the hardware processor 2P to the other hardware. The machine control unit 2 also includes a control panel 2CP. The control panel 2CP, such as a touch panel display, receives and outputs information from and to an operator. The touch panel of the control panel 2CP may be referred to as input interface 2IF. The display of the control panel 2CP may be referred to as the display 2DS. It is to be noted that the machine control unit 2 may further include the input interface 2IF, in addition to the touch panel. The input interface 2IF includes a button and a dial. The machine control unit 2 further includes a communication interface 2CF. The communication interface 2CF is connected to the network NW. This enables the machine control unit 2 to obtain, via the communication interface 2CF, at least part of the tool data 46 stored in the storage 90.

The memory 2M stores a machining program 41, a position calibration program 42, and mounting surface data 45. The machining program 41 is for machining a workpiece. The position calibration program 42 is programmed to refer to the mounting surface data 45 and at least part of the tool data 46 to estimate the nose position of the tool T, which nose position is specified by the machining program 41. For this purpose, the position calibration program 42 is preferably called from the machining program 41. Based on the estimated nose position, the position calibration program 42 transmits a control command to a servo driver DV. The servo driver DV controls the swivel driver 60 and the translation driver 61. The machining program 41, based on a command in the machining program, transmits a control command to an inverter INV. The inverter INV controls the swivel driver 71. The machine control unit 2 further includes a known external I/O interface 2IO. The external I/O interface 2IO is connected to the servo driver DV and the inverter INV to transmit these control commands. That is, the machine control unit 2 is configured to control the actuator 6.

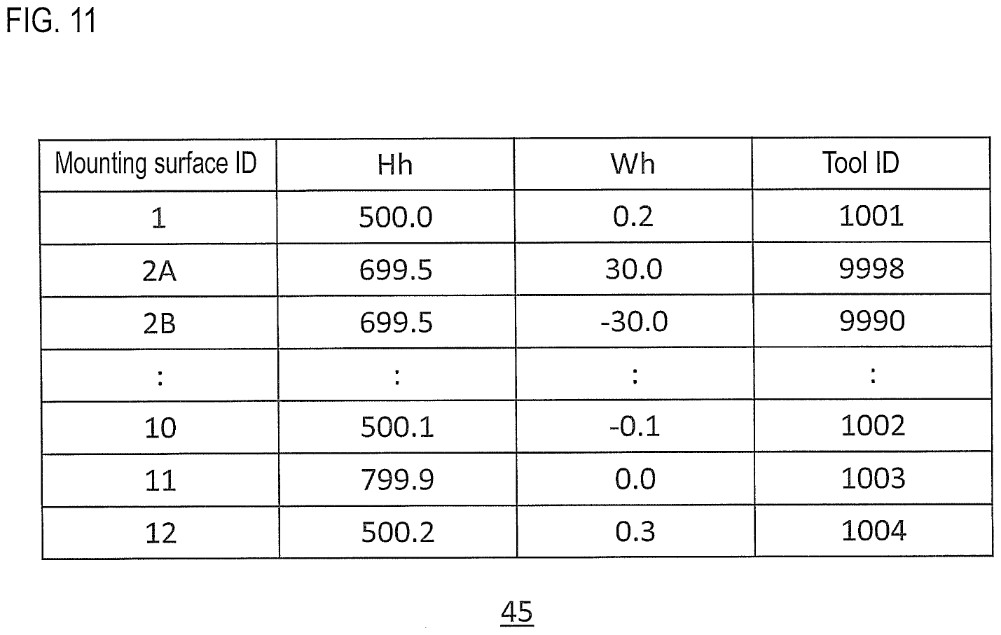

Next, details of the mounting surface data 45 will be described. FIG. 11 illustrates an example of the mounting surface data 45 according to the first embodiment. FIG. 9 is a schematic illustration of dimensions of the tool holder 5 according to the first embodiment and dimensions of the tool post 4 (the turret 40) according to the first embodiment. FIG. 9 illustrates the tool holder 5 and the tool post 4 with the X axis oriented upward and the Z axis oriented to the left on FIG. 9. FIG. 9 also illustrates the tool T in inserted position within the tool holder 5. The tool post 4 (the turret 40) has a tool post origin Ot. The tool post origin Ot is located on the first axis AX1. That is, the tool post 4 (the turret 40) is rotatable about a rotation axis (the first axis AX1) passing through the tool post origin Ot. The direction DT1 is approximately identical to the X axis direction, and the direction DT2 is approximately identical to the Z axis direction. In a precise sense, due to the influence of tool attachment misalignment on the tool holder 5, the position of the nose ED may slightly deviate in the Y-axis direction from a plane that passes through the tool post origin Ot and that is parallel to the X axis and the Z axis. However, the deviation in the Y axis direction aligns with the tangent direction of the rotation of the workpiece, becoming negligible in the deviation's influence on machining accuracy. There also may be a case that a machining error causes the mounting surface 8 to be slightly inclined from a plane parallel to the Y axis and the Z axis, which in turn causes the direction DT1 to be slightly inclined from the X axis direction and the direction DT2 to be slightly inclined from the Z axis direction. However, since the size of the tool T is small, the position misalignment of the nose ED caused by these inclinations is negligible.

As described above, the tool T has the tool reference point Pt, which is substantially identical to the holder reference point Ph when the tool T is attached to the tool holder 5. Since the tool holder 5 is capable of holding the tool T reproducibly, the tool reference point Pt can be considered to remain unchanged if any tool T attachable to the tool holder 5 is attached to the tool holder 5. Referring to FIG. 11, the mounting surface data 45 includes a correlation between: the identifier (mounting surface ID) of a mounted surface, among the plurality of mounting surfaces 8, on which the tool holder 5 is mounted; a distance Hh, which is a distance in the X axis direction between the tool post origin Ot and the holder reference point Ph; a distance Wh, which is a distance in the Z axis direction between the tool post origin Ot and the holder reference point Ph; and the tool T attached to the tool holder 5. In the following description, the tool T defined in the mounting surface data 45 may be referred to as attached tool. While in FIG. 11 the correlation is expressed in table form, the mounting surface data 45 may be expressed in any other form insofar as the mounting surface data 45 has a data structure that can describe the correlation. Other examples of the data structure include a list, an array, and a database.

The numerical part of the mounting surface ID indicates station number. A suffix (A or B) is attached to the numerical part of a mounting surface ID in a case that a double holder 5B is mounted on the mounting surface 8 corresponding to the station number of the mounting surface ID. The suffix is used to distinguish the insertion holes 5h1 and 5h2 of the double holder from each other. For example, among two holder reference points Ph determined by the insertion holes 5h1 and 5h2, the holder reference point Ph with a higher z-coordinate value (closer to the workpiece holder 7) may be identified as A, and the holder reference point Ph with a lower z-coordinate (farther away from the workpiece holder 7) may be identified as B.

In the following description of the embodiment, one of the distance Hh and the distance Wh will be referred to as first distance, and the other one of the distance Hh and the distance Wh will be referred to as fourth distance. One of the X axis direction and the Z axis direction that corresponds to an orientation serving as a reference of the first distance will be referred to as first direction, and the other one of the X axis direction and the Z axis direction that corresponds an orientation serving as a reference of the fourth distance will be referred to as second direction. That is, in a case that the distance Hh is the first distance and the distance Wh is the fourth distance, the X axis direction is the first direction and the Z axis direction is the second direction. In a case that the distance Wh is the first distance and the distance Hh is the fourth distance, the Z axis direction is the first direction and the X axis direction is the second direction. In other words, the first direction is a direction perpendicular to the first axis AX1 or a direction parallel to the first axis AX1.

According to the above-described definitions, the memory 2M stores the first distance (one of Hh and Wh) in the first direction (one of the X axis direction and the Z axis direction) between the holder reference point Ph of the tool holder 5 and the tool post origin Ot at the time when the mounted surface is adjusted to the indexing position and the attached tool is attached to the tool holder 5. The memory 2M stores the fourth distance (the other of Hh and Wh) in the second direction (the other one of the X axis direction and the Z axis direction), which is orthogonal to the first direction, between the holder reference point Ph of the tool holder 5 and the tool post origin Ot at the time when the mounted surface is adjusted to the indexing position and the attached tool is attached to the tool holder 5. The memory 2M can be regarded as storing a second correlation between the identifier of the mounted surface (the numerical part of the mounting surface ID), the first distance, and the identifier (tool ID) of the attached tool. The memory 2M can be regarded as storing a fourth correlation between the identifier of the mounted surface, the fourth distance, and the identifier of the attached tool.

Further, the direction DT1 can be regarded as being identical to the X axis direction, and the direction DT2 can be regarded as being identical to the Z axis direction. In the following description of the embodiment, either the length Ht or the length Wt that is based on a direction that can be regarded as being identical to the first direction, which is either the direction DT1 or the direction DT2, will be referred to as second distance. That is, the second distance is a distance in the first direction between the tool reference point Pt and the nose ED. Also, either the length Ht or the length Wt that is based on a direction that can be regarded as being identical to the second direction, which is either the direction DT1 or the direction DT2, will be referred to as fifth distance. That is, the fifth distance is a distance in the second direction between the tool reference point Pt and the nose ED. In this respect, the tool presetter 95 can be regarded as being configured to: obtain the identifier (tool ID) of the tool T; and in a state in which the measured tool, which is the tool T identified by the obtained identifier, is removed from the tool holder 5, measure the second distance for the measured tool. The storage 90 can be regarded as storing a first correlation between the identifier (tool ID) of the candidate tool (measured tool) attachable to the tool holder 5 and the second distance (one of Ht and Wt) in the first direction (one of the direction DT1 and the direction DT2) between the holder reference point Ph and the nose ED at the time when the mounted surface is adjusted to the indexing position and the candidate tool is attached to the tool holder 5. The storage 90 can be regarded as storing a third correlation between the identifier (tool ID) of the candidate tool (measured tool) and the fifth distance (the other of Ht and Wt) in the second direction (the other one of the direction DT1 and the direction DT2) at the time when the candidate tool is attached to the tool holder 5.

While the tool holder 5 is capable of holding the tool T reproducibly, the reproducibility of the surface machining accuracy on the plurality of mounting surfaces is not as high as the reproducibility of the tool holder 5. Therefore, the difference between the maximum value and the minimal value of the first distance among the plurality of mounting surfaces 8 is larger than the range of variation in the distance in the first direction between the holder reference point Ph and the nose ED at the time when the same tool T is attached to the tool holder 5. The difference between the maximum value and the minimal value of the second distance among the plurality of mounting surfaces 8 is larger than the range of variation in the distance in the second direction between the holder reference point Ph and the nose ED at the time when the same tool T is attached to the tool holder 5.

While the tool holder 5 is capable of holding the tool T reproducibly, the reproducibility of the mounting of the tool holder 5 is not as high as the reproducibility of the tool holder 5. Therefore, the range of variation in the position of the holder reference point Ph in the first direction at the time when the tool holder 5 is mounted on the same mounting surface 8 is larger than the range of variation in the distance in the first direction between the holder reference point Ph and the nose ED at the time when the same tool T is attached to the tool holder 5. The range of variation in the position of the holder reference point Ph in the second direction at the time when the tool holder 5 is mounted on the same mounting surface 8 is larger than the range of variation in the distance in the second direction between the holder reference point Ph and the nose ED at the time when the same tool T is attached to the tool holder 5.

Next, a method of inputting the tool ID (the identifier of the attached tool) illustrated in FIG. 11 will be described. The input interface 2IF of the machine control unit 2 includes the above-described known tag reader capable of reading the tag TAG of the tool T. When the operator attaches the tool T to the tool holder 5, the operator inputs a mounting surface ID corresponding to the insertion hole 5h of the tool holder 5 by selecting the mounting surface ID on the control panel 2CP or the input interface 2IF. Then, the operator inputs the tool ID of the attached tool from the tag reader. In this manner, the operator is able to input the tool ID of the attached tool in correlation with the mounting surface ID. There may be a case that a tag reader is built in the turret tool rest to read the attached tool when the operator attaches the attached tool to the mounting surface of the tool post. In this case, if the attached tool does not correspond to the correlation, an alarm may be displayed on the screen.

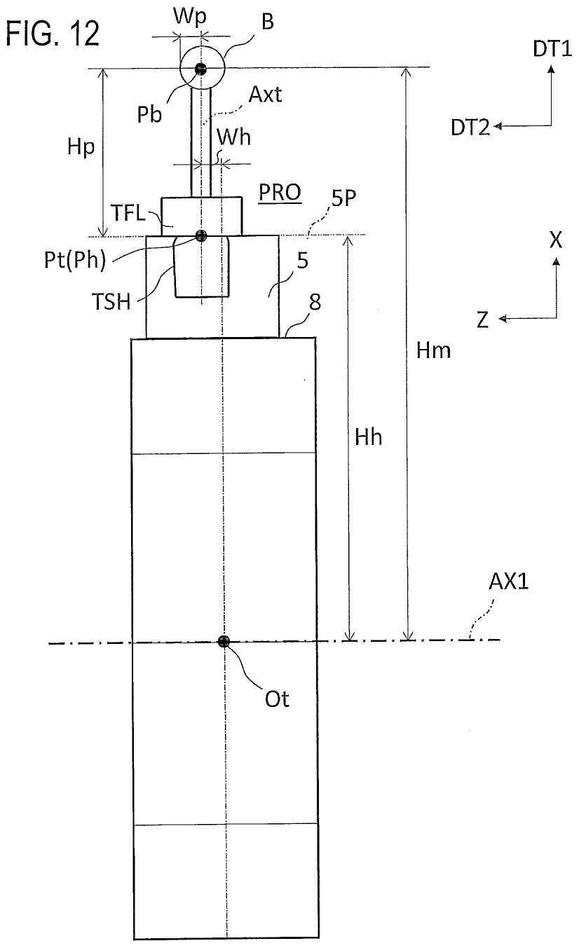

Next, a method of inputting and measuring the distance Hh and the distance Wh will be described. FIG. 12 is a schematic illustration of a method of measuring the holder reference point Ph of the tool holder 5. As illustrated in FIG. 12, a measurement tool PRO is attached to the tool holder 5. An example of the measurement tool PRO is a probe. The measurement tool PRO has a tool shaft TSH, which is identical in configuration to the tool shaft TSH of the tool T. The measurement tool PRO may further include a tool flange TFL, which includes an engagement groove GV or at least two posture adjustment surfaces OAS. This enables the measurement tool PRO to be attached to the tool holder 5. The measurement tool PRO includes a sphere B at a leading end portion of the measurement tool

PRO. A center of the sphere B will be referred to as measurement target Pb. That is, the measurement tool PRO includes the measurement target Pb. The distance, Hp, between the measurement target Pb and the tool reference point Pt and the radius, Wp, of the sphere are known. By a known method of bringing the sphere B into contact with the workpiece holder 7 or a workpiece having a known shape, the distance, Hm, in the X axis direction between the measurement target Pb and the tool post origin Ot and the distance Wh in the Z axis direction between the measurement target Pb and the tool post origin Ot are measured. By subtracting the distance Hp from the distance Hm, the distance Hh can be obtained.

That is, the first distance (one of Hh and Wh) is a value obtained from a measurement value (one of Hm and Wh) of the distance in the first direction (one of the X axis direction and the Z axis direction) between the measurement target Pb and the tool post origin Ot at the time when the mounted surface, among the plurality of mounting surfaces 8, on which the tool holder 5 is mounted is adjusted to the indexing position and the measurement tool PRO is attached to the tool holder 5, and obtained based on a seventh distance (one of Hp and distance 0) in the first direction between the holder reference point Ph and the measurement target Pb at the time when the mounted surface is adjusted to the indexing position and the measurement tool PRO is attached to the tool holder 5. The fourth distance (the other of Hh and Wh) is a value obtained from a measurement value (the other one of Hm and Wh) of the distance in the second direction (the other one of the X axis direction and the Z axis direction) between the measurement target Pb and the tool post origin Ot at the time when the mounted surface, among the plurality of mounting surfaces 8, on which the tool holder 5 is mounted is adjusted to the indexing position and the measurement tool PRO is attached to the tool holder 5, and obtained based on an eighth distance in the second direction (the other one of Hp and distance 0) between the holder reference point Ph and the measurement target Pb at the time when the mounted surface is adjusted to the indexing position and the measurement tool PRO is attached to the tool holder 5.

The operator inputs the mounting surface ID corresponding to the insertion hole 5h of the tool holder 5 by selecting the mounting surface ID on the control panel 2CP or the input interface 2IF. Then, the operator inputs the above-described measurement result. In this manner, the operator is able to the distance Hh and the distance Wh in correlation with the mounting surface ID. It is to be noted that the measurement tool PRO will not be limited to the above-described probe but may be a tool T having a known length Ht and a known length Wt. In this case, it is possible to measure the distance in the X axis direction between the nose ED of the known tool T and the tool post origin Ot and the distance in the Z axis direction using a gauge or a similar device and subtract the length Ht and the length Wt from the measurement result. In this manner, the distance Hh and the distance Wh may be measured. In this example, in a case that the distance Hh is the first distance, the known length Ht may be referred to as the seventh distance, and the known length Wt may be referred to as the eighth distance. In a case that the distance Wh is the first distance, the known length Wt may be referred to as the seventh distance, and the known length Ht may be referred to as the eighth distance.

Next, description will be made with regard to a method of estimating the position of the nose ED of the tool T performed by executing the position calibration program 42. The processor 2P, which executes the position calibration program 42, performs processing of obtaining the tool ID (the identifier of the attached tool) of the mounting surface data 45 via the tag reader (the input interface 2IF). Next, the processor 2P performs processing of obtaining, from the storage 90, lengths Ht and Wt (second distance and fifth distance) corresponding to the identifier (the tool ID of the tool data 46) of the candidate tool (measured tool) that is identical to the identifier of the attached tool. After the obtaining processing, the memory 2M may store the tool data 46. Next, the processor 2P obtains, from the T code number described in the machining program 41, the identifier (the numerical part of the mounting surface ID) of the mounting surface 8 adjusted to the indexing position. Next, the processor 2P determines, from the mounting surface data 45, the distances Hh and Wh and the identifier (tool ID) of the attached tool based on the obtained identifier of the mounting surface. Based on the obtained length Ht and the distance Hh in the mounting surface data 45, the processor 2P performs processing of estimating the distance, Ht+Hh, in the X axis direction between the tool post origin Ot and the nose ED of the attached tool. Lastly, based on the obtained length Wt and the distance Wh in the mounting surface data 45, the processor 2P performs processing of estimating the distance, Wt+Wh, in the Z axis direction between the tool post origin Ot and the nose ED of the attached tool. In a case that the distance Hh is the first distance and the length Ht is the second distance, the distance Ht+Hh will be referred to third distance. In a case that the distance Wh is the fourth distance and the length Wt is the fifth distance, the distance Wt+Wh will be referred to sixth distance. In a case that the distance Wh is the first distance and the length Wt is the second distance, the distance Wt+Wh will be referred to third distance. In a case that the distance Hh is the fourth distance and the length Ht is the fifth distance, the distance Ht+Hh will be referred to sixth distance. The processor 2P, which executes the machining program 41, controls the actuator 6 based on the third distance and the sixth distance.

### Flow of Processing of Method of Estimating Nose Position in Lathe 1

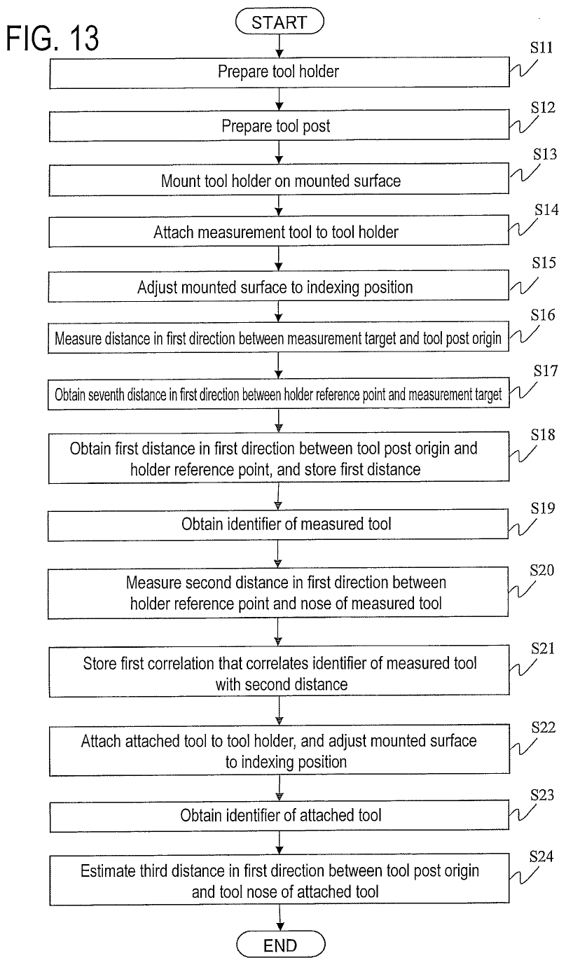

Next, the method of estimating the nose position in the lathe 1 will be described. FIG. 13 is a flowchart of processing of the method of estimating the nose position in the lathe 1. Referring to FIG. 13, at step S11 of the method, a tool holder 5 is prepared which has a holder reference point Ph and to which a tool T having a nose ED is attachable. At step S12 of the method, a tool post 4 is prepared which has a tool post origin Ot and includes a plurality of mounting surfaces 8. At step S13 of the method, the tool holder 5 is mounted on a mounted surface among the plurality of mounting surfaces 8. At step S14 of the method, the measurement tool PRO, which has the measurement target Pb, is attached to the tool holder 5. At step S15 of the method, the tool post 4 is moved to adjust the above-described mounted surface to the indexing position. At step S16 of the method, the distance (in the example illustrated in FIG. 12, one of the distance Hm and the distance Wh) in the first direction (one of the X axis direction and the Z axis direction) between the measurement target Pb and the tool post origin Ot is measured. At step S16, it is also possible to measure the distance (in the example illustrated in FIG. 12, the other one of the distance Hm and the distance Wh) in the second direction (the other one of the X axis direction and the Z axis direction) between the measurement target Pb and the tool post origin Ot.

At step S17 of the method, the seventh distance (in the example illustrated in FIG. 12, one of Hp and distance 0) in the first direction (one of the X axis direction and the Z axis direction) between the holder reference point Ph and the measurement target Pb at the time when the mounted surface is adjusted to the indexing position and the measurement tool PRO is attached to the tool holder 5 is obtained. This obtaining processing means to obtain known dimension data pf the measurement tool PRO. At step S18 of the method, based on the measured distance (in the example illustrated in FIG. 12, one of the distance Hm and the distance Wh) and the seventh distance (in the example illustrated in FIG. 12, one of Hp and distance 0), the first distance (one of Hh and Wh) in the first direction (one of the X axis direction and the Z axis direction) between the tool post origin Ot and the holder reference point Ph is obtained. The first distance is stored in the memory 2M. At step S18 of the method, based on the measured distance (in the example illustrated in FIG. 12, the other one of the distance Hm and the distance Wh) and the eighth distance (in the example illustrated in FIG. 12, the other one of Hp and distance 0), the fourth distance (the other of Hh and Wh) in the second direction (the other one of the X axis direction and the Z axis direction) between the tool post origin Ot and the holder reference point Ph may be obtained. The fourth distance may be stored in the memory 2M.

At step S19 of the method, the tool presetter 95 obtains the identifier (tool ID) of the measured tool. At step S20 of the method, the tool presetter 95 measures the second distance (one of Ht and Wt) in the first direction (one of the X axis direction and the Z axis direction) between the holder reference point Ph and the nose ED of the measured tool at the time when the mounted surface is adjusted to the indexing position and the measured tool is attached to the tool holder 5. At step S20, the tool presetter 95 may measure the fifth distance (the other of Ht and Wt) in the second direction (the other one of the X axis direction and the Z axis direction) between the tool reference point Pt and the nose ED of the measured tool at the time when the mounted surface is adjusted to the indexing position and the measured tool is attached to the tool holder 5.

At step S21 of the method, the storage 90 stores a first correlation that correlates the identifier (tool ID) of the measured tool with the second distance (one of Ht and Wt). At step S21, the storage 90 may store a third correlation that correlates the identifier (tool ID) of the measured tool with the fifth distance (the other of Ht and Wt).

At step S22 of the method, the attached tool is attached to the tool holder 5. The mounted surface is adjusted to the indexing position. At step S23 of the method, the lathe 1 obtains the identifier (tool ID) of the attached tool. At step S24 of the method, the processor 2P, which executes the position calibration program 42, obtains a second distance (one of Ht and Wt) corresponding to the identifier of the measured tool that is identical to the identifier of the attached tool. Then, based on the obtained second distance and the first distance (one of Hh and Wh), the processor 2P estimates a third distance (one of Hh+Ht and Wh+Wt) in the first direction (one of the X axis direction and the Z axis direction) between the tool post origin Ot and the nose ED of the attached tool. At step S24, the processor 2P may obtain a fifth distance (the other of Ht and Wt) corresponding to the identifier of the measured tool that is identical to the identifier of the attached tool. Then, based on the obtained fifth distance and the fourth distance (the other of Hh and Wh), the processor 2P may estimate a sixth distance (the other one of Hh+Ht and Wh+Wt) in the second direction (the other one of the X axis direction and the Z axis direction) between the tool post origin Ot and the nose ED of the attached tool.

### Features and Effects of Lathe Machining System According to This Embodiment and Method According to This Embodiment of Estimating Nose Position in Lathe 1

The lathe 1 according to this embodiment, the lathe machining system 100 according to this embodiment, and the method according to this embodiment of estimating the nose position in the lathe 1 obtain the identifier of the attached tool; obtain, from the storage 90, a second distance corresponding to the identifier of the candidate tool that is identical to the identifier of the attached tool, the storage 90 storing the first correlation between the identifier of the candidate tool attachable to the tool holder 5 and the second distance in the first direction between the holder reference point Ph and the nose ED at the time when the mounted surface is adjusted to the indexing position and the candidate tool is attached to the tool holder 5; and based on the obtained second distance and the first distance, estimate the third distance in the first direction between the tool post origin Ot and the nose ED of the attached tool. This shortens the arrangement time for measuring the tool length for measuring position misalignments of positions of noses of a plurality of tools.

### Second Embodiment

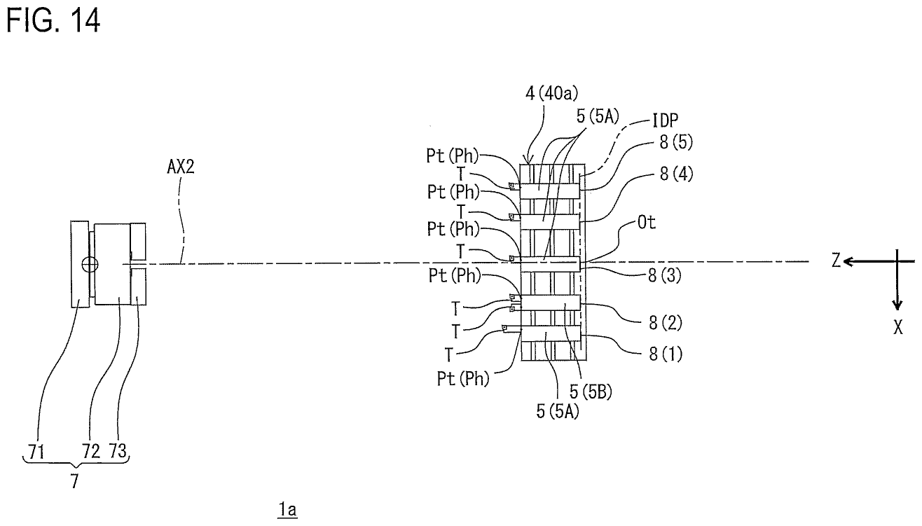

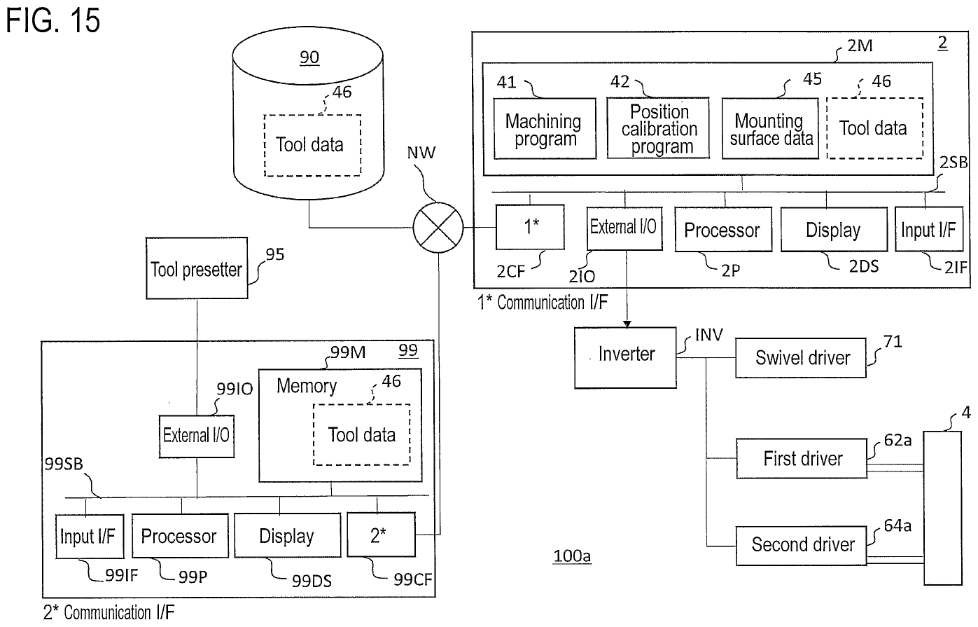

FIG. 14 illustrates a schematic configuration of main parts of a lathe 1a according to the second embodiment. FIG. 15 is a block diagram of a hardware configuration of a lathe machining system 100a according to the second embodiment. The configuration of the second embodiment shares many similarities with the configuration of the first embodiment. Therefore, the following description will focus solely on the differences, and the shared similarities will be omitted from the description.

As illustrated in FIG. 14, in the lathe 1a according to the second embodiment, a plurality of tools T are attached to the tool post 4 in a comb-shaped configuration. The tool post 4 is moved in XZ directions to bring the plurality of tools T into contact with the workpiece, machining the workpiece. In this embodiment, the tool post 4 of this kind will be referred to the comb-tooth tool post 40a. In FIG. 14, a workpiece holder 7 is illustrated. This workpiece holder 7 is identical in configuration to the workpiece holder 7 according to the first embodiment. The Z axis direction preferably extends along the rotation axis, AX2, of the workpiece holder 7, and the X axis direction is preferably oriented in a vertical direction relative to the rotation axis AX2 of the workpiece holder 7. The configuration of lathe machining system 100a is identical in large part to the configuration of the lathe machining system 100. In the lathe machining system 100a, however, the swivel driver 60 is omitted; a first driver 62a is configured to drive the comb-tooth tool post 40a in the X axis direction; and a second driver 64a is configured to drive the comb-tooth tool post 40a in the Z axis direction.

In this configuration, tool holders 5 are respectively fitted in a plurality of grooves of the comb-tooth tool post 40a. As illustrated in FIG. 14, innermost surfaces of the plurality of grooves can be regarded as a plurality of mounting surfaces 8. The number in parentheses following the reference symbol of each mounting surface indicates the station number described above. As illustrated in FIG. 14, the plurality of mounting surfaces 8 are provided on an identical plane IDP. A tool post origin Ot of the comb-tooth tool post 40a is determined for each lathe 1a. On each mounting surface 8, the single holder 5A or the double holder 5B, which is capable of holding a plurality of tools T, can be mounted. In the first embodiment, the direction DT1 is set to be approximately identical to the X axis direction, and the direction DT2 is set to be approximately identical to the Z axis direction. In the second embodiment, however, the direction DT1 is set to be approximately identical to the Z axis direction, and the direction DT2 is set to be approximately identical to the X axis direction. In this embodiment, the posture of the comb-tooth tool post 40a remains unchanged. Therefore, the mounted surface, among the plurality of mounting surfaces 8, on which the tool holder 5 is mounted, may be regarded as being adjusted to the indexing position.

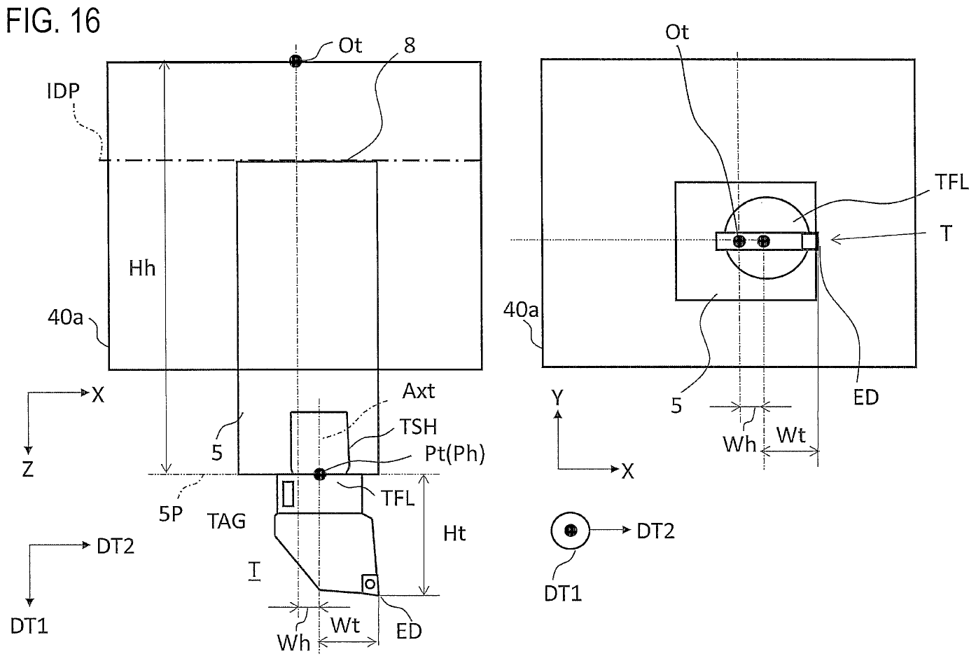

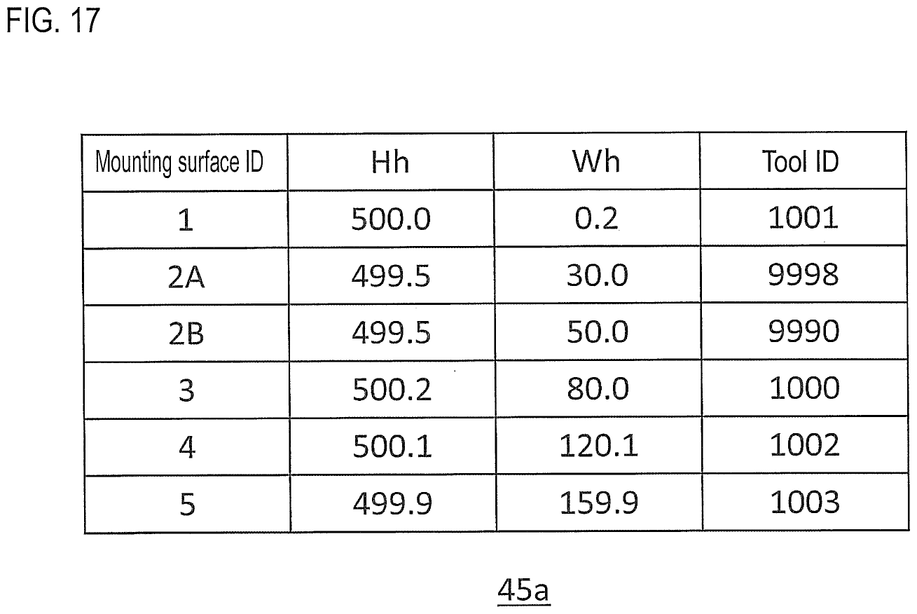

FIG. 16 is a schematic illustration of dimensions of the tool holder 5 according to the second embodiment and dimensions of the tool post 4 (the comb-tooth tool post 40a) according to the second embodiment. FIG. 17 illustrates an example of the mounting surface data 45a according to the second embodiment. Referring to FIGS. 16 and 17, the distance of the holder reference point Ph relative to the tool post origin Ot in the X direction is represented as Wh, and the distance of the holder reference point Ph relative to the tool post origin Ot in the Z direction is represented as Hh. These values can be obtained by the methods described in the first embodiment. As illustrated in FIG. 17, in this embodiment as well, there may be a case that the double holder 5B is mounted, as indicated by the suffix attached to the mounting surface ID. In this embodiment, the first direction can be regarded as one of the X axis direction and the Z axis direction, and the second direction can be regarded as the other one of the X axis direction and the Z axis direction. Therefore, the first direction is a normal direction of the identical plane IDP or a direction perpendicular to the normal direction. The second direction is the normal direction of the identical plane IDP or a direction perpendicular to the normal direction. In this respect, the processor 2P, which executes the position calibration program 42, is able to estimate the distance Hh+Ht in the Z direction between the tool post origin Ot and the nose ED based on the distance Hh and the length Ht. In this respect, the processor 2P, which executes the position calibration program 42, is able to estimate the distance Wh+Wt in the X direction between the tool post origin Ot and the nose ED based on the distance Wh and the length Wt.

It is to be noted that in the comb-tooth tool post 40a, the model illustrated in the right half of FIG. 16 has no deviation between the nose ED and the tool post origin Ot in the Y axis, which is perpendicular to the X axis. It is also possible, however, to take a deviation in the Y axis direction into consideration. Another possible example is to define the X axis as an axis extending in a direction from the Z axis toward the nose ED.

### Modifications

At least one or all of the functions of the logic of the position calibration program 42 may be implemented by a dedicated processor and/or an integrated circuit. The position calibration program 42 may not necessarily be stored in the memory 2M, but may be recorded in a disc (disk) such as a floppy disk, an optical disc, a CD-ROM, and a magnetic disc; or a storage medium, such as an SD card, a USB memory, and external hard disc, that is removable from the machine control unit 2 and readable by the machine control unit 2.

The techniques recited in JP3648054B and JP2010-280028A assume that the attachment can be mounted on the tool spindle reproducibly, ensuring that any misalignment of the tool's nose is negligible. Once the position misalignment is measured, the same attachment can be mounted on the tool spindle again with the previously measured position misalignment reused. In the tool holder recited in JP2022-035083A and the tool mounting section recited in JP2016-036868A, tools are attached to the tool post. This configuration does not necessarily allow for highly reproducible attachment to the tool post. Additionally, when the mounting surface of the lathe's tool post changes, the offset between an origin of the tool post and the mounting surface may also change. Under the circumstances, conventional practice was that each time a tool was attached to the lathe's tool post, the displacement between the nose of the tool and a reference position of the tool post was measured. As a result, there was an issue of prolonged arrangement time for the machine tool.

The embodiments provide a lathe in which a plurality of tools are simultaneously attachable to a tool post. The lathe shortens an arrangement time for measuring position misalignments of positions of noses of a plurality of tools. The embodiments also provide a lathe machining system that shortens the arrangement time. The embodiments also provide a method of estimating a nose position in a lathe such that the method shortens the arrangement time.

According to a first aspect of the present disclosure, a lathe includes a tool holder, a tool post, an actuator, and a machine control unit. The tool holder has a holder reference point, and a tool having a tool nose is attachable to the tool holder. The tool post has a tool post origin and has a plurality of mounting surfaces on which the tool holder is mountable. The actuator is configured to move the tool post to adjust each mounting surface of the plurality of mounting surfaces to an indexing position. The indexing position is determined in advance based on the structure of the lathe, and the lathe is configured to perform machining using the tool attached to the mounting surface moved to the indexing position. The machine control unit is configured to control the actuator. The machine control unit includes a memory and a processor. The processor is preferably a hardware processor. The memory is configured to store first distances in a first direction between the tool post origin and the holder reference point of the tool holder mounted on the mounting surfaces, respectively, an attached tool being attached to the tool holder, one of the mounting surfaces on which the tool holder is mounted being a mounted surface, the mounted surface being adjusted to the indexing position. The processor is configured to obtain an identifier of the attached tool. The processor is also configured to, obtain, from a storage, a second distance in the first direction between the holder reference point and a tool nose of the attached tool with the mounted surface being adjusted to the indexing position, the identifier of the attached tool corresponding to an identifier of one of candidate tools, the storage storing first correlation between identifiers of the candidate tools and the second distances between tool noses of the candidate tools and the holder reference point, respectively. The processor is also configured to, based on the second distance that has been obtained and the first distances, estimate a third distance in the first direction between the tool post origin and the tool nose of the attached tool to control the actuator based on the third distance. The storage may be the above-described memory or a storage provided outside the lathe. The second distance is preferably a value measured in a state in which the candidate tool is removed from the tool holder.

According to a second aspect of the present disclosure, in the lathe according to the first aspect, when the tool is attached to the tool holder, the tool has a tool reference point that is substantially identical to the holder reference point. The second distance is a distance in the first direction between the tool reference point and the tool nose. It is to be noted that in a case that the tool is attached to the tool holder via an adapter, the tool reference point may be outside the tool. Alternatively, an adapter-equipped tool may be regarded as the above-described tool.

According to a third aspect of the present disclosure, in the lathe according to the first or second aspect, the tool post is a turret. The plurality of mounting surfaces are preferably a plurality of surfaces which define a single turret and on which a tool holder is mounted.

According to a fourth aspect of the present disclosure, in the lathe according to the third aspect, the first distances for the plurality of mounting surfaces varies from mounting surface to mounting surface. A difference between a maximum value and a minimal value of the first distances for the plurality of mounting surfaces is larger than a range distances in the first direction between the holder reference point and the tool nose of an identical tool that is variously attached to the tool holder.

According to a fifth aspect of the present disclosure, in the lathe according to the fourth aspect, a range of positions of the holder reference point in the first direction with the tool holder variously mounted on an identical mounting surface is larger than the range of the distances in the first direction between the holder reference point and the tool nose of the identical tool that is variously attached to the tool holder.

According to a sixth aspect of the present disclosure, in the lathe according to any one of the third to fifth aspects, the tool post is rotatable about a rotation axis passing through the tool post origin, and the first direction is a direction perpendicular to the rotation axis or a direction parallel to the rotation axis.

According to a seventh aspect of the present disclosure, the lathe according to the sixth aspect further includes a workpiece holder configured to hold a workpiece rotatably about a workpiece rotation axis parallel to the rotation axis. The first direction is a direction perpendicular to the rotation axis and the workpiece rotation axis.

According to an eighth aspect of the present disclosure, in the lathe according to the first or second aspect, the plurality of mounting surfaces are provided on an identical plane.

According to a ninth aspect of the present disclosure, in the lathe according to the eighth aspect, the first direction is a normal direction of the identical plane or a direction perpendicular to the normal direction.

According to a tenth aspect of the present disclosure, in the lathe according to any one of the first to ninth aspects, the memory is configured to store fourth distances in a second direction orthogonal to the first direction between the tool post origin and the holder reference point of the tool holder mounted on mounting surfaces, respectively, the attached tool being attached to the tool holder, the mounted surface being adjusted to the indexing position. The processor is configured to obtain, from the storage, a fifth distance of the attached tool in the second direction, the identifier of the attached tool corresponding to the identifier of the one of the candidate tools, the storage storing third correlation between the identifiers of the candidate tools and the fifth distances in the second direction with the candidate tools being attached to the tool holder, respectively. The processor is also configured to, based on the fifth distance that has been obtained and the fourth distances, estimate a sixth distance between the tool post origin and the tool nose of the attached tool to control the actuator based on the sixth distance.

According to an eleventh aspect of the present disclosure, in the lathe according to any one of the first to tenth aspects, the tool has a tool center axis, and the tool holder has a target center axis. The tool holder includes one of a guide surface and a guided surface, the guide surface extending along the target center axis in an insertion direction from one of the tool holder and the tool toward another of the tool holder and the tool to gradually approach the target center axis along the insertion direction so that the tool center axis substantially share a common axis with the target center axis, the guided surface being configured to be guided by the guide surface. The tool holder includes either at least two surfaces of at least two posture adjustment surfaces and at least two contact surfaces, the at least two posture adjustment surfaces crossing a circumferential direction centered around the common axis, the at least two contact surfaces being configured to abut against the at least two posture adjustment surfaces, respectively,. The tool holder includes one of an engagement jaw and an engagement groove. The engagement jaw is configured to regulate or deregulate movement of the tool in the insertion direction and a withdrawal direction opposite to the insertion direction. The engagement groove is provided around the common axis to be engageable with the engagement jaw. The tool includes another of the guide surface and the guided surface, remaining at least two surfaces of the at least two posture adjustment surfaces and the at least two contact surfaces, the remaining at least two surfaces being other than the either at least two surfaces, and another of the engagement jaw and the engagement groove.

According to a twelfth aspect of the present disclosure, in the lathe according to any one of the first to eleventh aspects, a measurement tool having a measurement target is attachable to the tool holder. The first distance is a value obtained from a measurement value of a distance in the first direction between the measurement target and the tool post origin in a state in which the mounted surface is adjusted to the indexing position and the measurement tool is attached to the tool holder, and obtained based on a seventh distance in the first direction between the holder reference point and the measurement target with the measurement tool being attached to the tool holder, the mounted surface being adjusted to the indexing position. It is to be noted that the above-described measurement tool preferably has the above-described tool reference point, and the seventh distance is preferably a distance in the first direction between the tool reference point and the measurement target.

According to a thirteenth aspect of the present disclosure, in the lathe according to any one of the first to twelfth aspects, the memory is configured to store second correlation between an identifier of the mounted surface, the first distance, and the identifier of the attached tool. The processor is configured to obtain an identifier of a mounting surface adjusted to the indexing position, and configured to determine the first distance and the identifier of the attached tool based on the identifier of the mounting surface that has been obtained.

According to a fourteenth aspect of the present disclosure, in the lathe according to the twelfth aspect, the memory is configured to store fourth correlation between an identifier of the mounted surface, one of the fourth distances, and the identifier of the attached tool. The processor is configured to obtain the identifier of the mounting surface that is adjusted to the indexing position, and determines the one of the fourth distances and the identifier of the attached tool based on the identifier of the mounting surface that has been obtained.

According to a fifteen aspect of the present disclosure, a lathe machining system includes the lathe according to the thirteenth aspect or the fourteenth aspect, a tool presetter configured to obtain an identifier of the tool and to measure the second distance for a measured tool identified by the identifier of the tool that has been obtained in a state in which the measured tool is removed from the tool holder, a network via which the machine control unit and the tool presetter communicate with each other, and the storage connected to the network. The storage is configured to store the first correlation such that the first correlation correlates the identifier of the measured tool with data indicating the second distance that has been measured. The processor is configured to obtain the second distance such that the second distance corresponds to the identifier of the measured tool that is identical to the identifier of the attached tool.

According to a sixteen aspect of the present disclosure, a method of estimating a nose position in a lathe includes preparing a tool holder which has a holder reference point and to which a tool having a tool nose is attachable, and preparing a tool post having a tool post origin and having a plurality of mounting surfaces. The method includes mounting the tool holder on a mounted surface among the plurality of mounting surfaces, and attaching, to the tool holder, a measurement tool having a measurement target. The method includes moving the tool post to adjust the mounted surface to an indexing position, and measuring a distance in a first direction between the measurement target and the tool post origin. The method includes obtaining a seventh distance in the first direction between the holder reference point and the measurement target with the measurement tool being attached to the tool holder, the mounted surface being adjusted to the indexing position. The method includes, based on the measured distance and the seventh distance, obtaining a first distance in the first direction between the tool post origin and the holder reference point to store the first distance. The method includes obtaining an identifier of a measured tool, measuring a second distance in the first direction between the holder reference point and the tool nose of the measured tool when the measured tool is attached to the tool holder and the mounted surface is adjusted to the indexing position, and storing first correlation that correlates the identifier of the measured tool with the second distance. The method includes attaching an attached tool to the tool holder to adjust the mounted surface to the indexing position. The method includes obtaining an identifier of the attached tool, and obtaining the second distance corresponding to the identifier of the measured tool that is identical to the identifier of the attached tool, and estimating a third distance in the first direction between the tool post origin and the tool nose of the attached tool based on the second distance that has been obtained and the first distance.

According to a seventeenth aspect of the present disclosure, in the method of estimating the nose position according to the sixteenth aspect, when the tool is attached to the tool holder, the tool has a tool reference point that is substantially identical to the holder reference point. The second distance is a distance in the first direction between the tool reference point and the tool nose. It is to be noted that in a case that the tool is attached to the tool holder via an adapter, the tool reference point may be outside the tool. Alternatively, an adapter-equipped tool may be regarded as the above-described tool. The above-described measurement tool preferably has the above-described tool reference point, and the seventh distance is preferably a distance in the first direction between the tool reference point and the measurement target.

According to an eighteenth aspect of the present disclosure, in the method of estimating the nose position according to the sixteenth or seventeenth aspect, the tool post is a turret. The plurality of mounting surfaces are preferably a plurality of surfaces which define a single turret and on which a tool holder is mounted.

According to a nineteenth aspect of the present disclosure, in the method of estimating the nose position according to the eighteenth aspect, a difference between a maximum value and a minimal value of the first distances for the plurality of mounting surfaces is larger than a range of distances in the first direction between the holder reference point and the tool nose of an identical tool that is variously attached to the tool holder.

According to a twentieth aspect of the present disclosure, in the method of estimating the nose position according to the nineteenth aspect, a range of positions of the holder reference point in the first direction with the tool holder variously mounted on an identical mounting surface is larger than the range of the distances in the first direction between the holder reference point and the tool nose of the identical tool that is variously attached to the tool holder.

According to a twenty-first aspect of the present disclosure, in the method of estimating the nose position according to any one of eighteenth to twentieth aspects, the tool post is rotatable about a rotation axis passing through the tool post origin, and the first direction is a direction perpendicular to the rotation axis or a direction parallel to the rotation axis.

According to a twenty-second aspect of the present disclosure, in the method of estimating the nose position according to the twenty-first aspect, the first direction is a direction perpendicular to the rotation axis and the workpiece rotation axis. The workpiece attached to the lathe is held rotatably about a workpiece rotation axis parallel to the rotation axis.

According to a twenty-third aspect of the present disclosure, in the method of estimating the nose position according to the sixteenth or seventeenth aspect, the plurality of mounting surfaces are provided on an identical plane.

According to a twenty-fourth aspect of the present disclosure, in the method of estimating the nose position according to the twenty-third aspect, the first direction is a normal direction of the identical plane or a direction perpendicular to the normal direction.

According to a twenty-fifth aspect of the present disclosure, the method of estimating the nose position according to any one of the sixteenth to twenty-fourth aspects, includes measuring an additional distance between the measurement target and the tool post origin in a second direction orthogonal to the first direction. The method includes obtaining an eighth distance in the second direction between the holder reference point and the measurement target with the measurement tool being attached to the tool holder, the mounted surface being adjusted to the indexing position. The method includes, based on the measured additional distance and the eighth distance, obtaining a fourth distance in the second direction between the tool post origin and the holder reference point to store the fourth distance. The method includes measuring a fifth distance in the second direction between the holder reference point and the tool nose of the measured tool when the measured tool is attached to the tool holder and the mounted surface is adjusted to the indexing position, and storing third correlation that correlates the identifier of the measured tool with the fifth distance. The method includes obtaining an identifier of the attached tool, obtaining the fifth distance corresponding to the identifier of the measured tool that is identical to the identifier of the attached tool, and, based on the fifth distance that has been obtained and the fourth distance, estimating a sixth distance in the second direction between the tool post origin and the tool nose of the attached tool. It is to be noted that the fifth distance is preferably a distance in the second direction between the above-described tool reference point and tool nose.

According to a twenty-sixth aspect of the present disclosure, the method of estimating the nose position according to any one of the sixteenth to twenty-fifth aspects, further includes storing second correlation between an identifier of the mounted surface, the first distance, and the identifier of the attached tool. The method further includes obtaining an identifier of the mounting surface adjusted to the indexing position, and determining the first distance and the identifier of the attached tool based on the identifier of the mounting surface that has been obtained.

According to a twenty-seventh aspect of the present disclosure, the method of estimating the nose position according to the twenty-fifth aspect further includes storing fourth correlation between an identifier of the mounted surface, one of the fourth distances, and the identifier of the attached tool. The method further includes obtaining an identifier of the mounting surface adjusted to the indexing position, and determining the one of the fourth distances and the identifier of the attached tool based on the identifier of the mounting surface that has been obtained.

Turret lathes and machine tools equipped with tool posts with tools arranged in a comb-shaped configuration have a large number of mounted surfaces. Once a tool holder/tool mounting portion is mounted on such turret or machine tool, the tool holder/tool mounting portion is kept fixed to a mounted surface, and a tool attached to the tool holder/tool mounting portion is replaced with another tool. In this respect, tools can be attached to the tool holder/tool mounting portion with reproducibility high enough to ensure that any position misalignment of the position of the tool nose is negligible. Such features of machine tools are used in the lathe according to the first aspect, the machine tool system according to the fifteenth aspect including the lathe according to the first aspect, and the method according to the sixteenth aspect of estimating the nose position. Specifically, when an attached tool is attached anew to a tool holder, an identifier of the attached tool is obtained, a second distance is obtained using the first correlation, and a third distance in the first direction between the tool post origin and the nose of the attached tool is estimated based on the obtained second distance and a first distance. With this configuration, once the tool holder/tool mounting portion is fixed to the mounted surface and the first distance for the holder reference point is stored, the first distance can be reused when the tool on the tool holder/tool mounting portion is replaced with another tool. Also with the above configuration, the second distance can be measured by an external tool presetter or a similar device, even if a tool is not attached to the tool holder/tool mounting portion. This shortens the arrangement time for measuring displacements of the nose positions of a plurality of tools.

In the lathe according to the second aspect, the lathe machining system according to the fifteenth aspect including the lathe according to the second aspect, and the method according to the seventeenth aspect of estimating the nose position, the second distance is the distance between the tool nose and a tool reference point substantially identical to the holder reference point at a time attachment to the tool holder. This makes it easier for an external device to measure the second distance.

The lathe according to the third aspect, the lathe machining system including the lathe according to the third aspect, and the method according to the eighteenth aspect of estimating the nose position make it possible for the technical features of the first aspect to be applied to a plurality of mounted surfaces of a turret lathe.

In the lathe according to the fourth aspect, the lathe machining system according to the fifteenth aspect including the lathe according to the fourth aspect, and the method according to the nineteenth aspect of estimating the nose position, the machining error on the plurality of mounted surfaces of the turret lathe is larger than the range of position misalignment of the position of the nose of the tool attached to the tool holder. In such case as well, the machining error on the plurality of mounted surfaces of the turret lathe is calibrated by the first distance for the holder reference point. Therefore, it is not necessary to perform a separate calibration process on the machining error on the plurality of mounted surfaces of the turret lathe. This further improves effectiveness of the arrangement for measuring displacements of the nose positions of the plurality of tools.

In the lathe according to the fifth aspect, the lathe machining system according to the fifteenth aspect including the lathe according to the fifth aspect, and the method according to the twentieth aspect of estimating the nose position, the mounting variation of the tool holders on an identical mounting surface is larger than the range of position misalignment of the position of the nose of the tool attached to the tool holder. In such case as well, the mounting variation of the tool holders is calibrated by the first distance for the holder reference point. Therefore, it is not necessary to perform a separate calibration process on the machining error on the plurality of mounted surfaces of the turret lathe. This further improves effectiveness of the arrangement for measuring displacements of the nose positions of the plurality of tools.

In the lathe according to the sixth aspect, the lathe machining system according to the fifteenth aspect including the lathe according to the sixth aspect, and in the method according to the twenty-first aspect of estimating the nose position, the lathe moves the turret in a direction perpendicular or parallel to the rotation axis of the turret lathe during a machining process. This makes it possible to accurately estimate the offset of the movement direction during the machining process, resulting in highly accurate machining.

In the lathe according to the seventh aspect, the lathe machining system according to the fifteenth aspect including the lathe according to the seventh aspect, and the method according to the twenty-second aspect of estimating the nose position, the lathe moves the turret in a direction perpendicular to the rotation axis of the turret lathe and the workpiece rotation axis during a machining process. This makes it possible to accurately estimate the offset of the movement direction during the machining process, resulting in highly accurate machining.

The lathe according to the eighth aspect, the lathe machining system according to the fifteenth aspect including the lathe according to the eighth aspect, and the method of estimating the nose position, according to the twenty-third aspect make it possible for the technical features of the first aspect to be applied to a tool post with a plurality of tools arranged in a comb-shaped configuration.

The lathe according to the ninth aspect, the lathe machining system according to the fifteenth aspect including the lathe according to the ninth aspect, and the method according to the twenty-fourth aspect of estimating the nose position, the lathe moves the tool post in a normal direction of the identical plane or in a direction perpendicular to the normal direction during a machining process. This makes it possible to accurately estimate the offset of the movement direction during the machining process, resulting in highly accurate machining.

The lathe according to the tenth aspect, the lathe machining system according to the fifteenth aspect including the lathe according to the tenth aspect, and the method according to the twenty-fifth aspect of estimating the nose position, the nose offset in the second direction perpendicular to the first direction can be calibrated.

In the lathe according to the eleventh aspect and in the lathe machining system according to the fifteenth aspect including the lathe according to the eleventh aspect, the tool holder positions the tool nose position relative to the holder reference point highly accurately within an allowance range of a few to several micrometers.

In the lathe according to the twelfth aspect, the lathe machining system according to the fifteenth aspect including the lathe according to the twelfth aspect, and the method according to the twenty-fifth aspect of estimating the nose position, the first distance can be obtained using the measurement tool. Thus, the first distance can be measured more easily than directly measuring the holder reference point. Additionally, the use of a measurement tool eliminates the need for directly measuring the holder reference point. This ensures that the first distance can be obtained even in a machine whose driver has a small movable range.

In the machine tool according to the thirteenth and fourteenth aspects, the machine tool system according to the fifteenth aspect including the machine tool according to the twelfth aspect, and the method according to the twenty-sixth and twenty-seventh aspects of estimating the nose position, the first distance (fourth distance) and the identifier of the attached tool can be managed for each mounting surface. This facilitates flexible handling of mounting surface rotation and attached tool replacement.

The technique disclosed in the embodiments shortens the arrangement time for measuring displacements of positions of noses of a plurality of tools.

In the present application, the term “comprise” and its variations are intended to mean open-ended terms, not excluding any other elements and/or components that are not recited herein. The same applies to the terms “include”, “have”, and their variations.

Also in the present application, a component suffixed with a term such as “member”, “portion”, “part”, “element”, “body”, and “structure” is intended to mean that there is a single such component or a plurality of such components.

Also in the present application, ordinal terms such as “first” and “second” are merely used for distinguishing purposes and there is no other intention (such as to connote a particular order) in using ordinal terms. For example, the mere use of “first element” does not connote the existence of “second element”; otherwise, the mere use of “second element” does not connote the existence of “first element”.

In the present disclosure, approximating language such as “approximately”, “about”, and “substantially” may be applied to modify any quantitative representation that could permissibly vary without a significant change in the final result obtained. All of the quantitative representations recited in the present application shall be construed to be modified by approximating language such as “approximately”, “about”, and “substantially”.

Also in the present application, the phrase “at least one of A and B” is intended to be interpreted as “only A”, “only B”, or “both A and B”.

Obviously, numerous modifications and variations of the present invention are possible in light of the above teachings. It is therefore to be understood that within the scope of the appended claims, the present invention may be practiced otherwise than as specifically described herein.

What is claimed is:

1. A lathe comprising:
a tool holder which has a holder reference point and to which a tool having a tool nose is attachable;
a tool post having a tool post origin and having mounting surfaces on which the tool holder is mountable;
an actuator configured to move the tool post to adjust each of the mounting surfaces to an indexing position;
a processor configured to control the actuator;
a memory storing:
first distances in a first direction between the tool post origin and the holder reference point of the tool holder mounted on the mounting surfaces, respectively, an attached tool being attached to the tool holder, one of the mounting surfaces on which the tool holder is mounted being a mounted surface, the mounted surface being adjusted to the indexing position; and
instructions that when executed by the processor, cause the processor to perform operations comprising:
obtaining an identifier of the attached tool;
obtaining, from a storage, a second distance in the first direction between the holder reference point and the tool nose of the attached tool with the mounted surface being adjusted to the indexing position, the identifier of the attached tool corresponding to an identifier of one of candidate tools, the storage storing first correlation between identifiers of the candidate tools and the second distances between the holder reference point and tool noses of the candidate tools, respectively; and
estimating, based on the first distances, the mounted surface, and the second distance that has been obtained, a third distance in the first direction between the tool post origin and the tool nose of the attached tool to control the actuator based on the third distance.

2. The lathe according to claim 1,
wherein when the tool is attached to the tool holder, the tool has a tool reference point that is substantially identical to the holder reference point, and
wherein the second distance is a distance in the first direction between the tool reference point and the tool nose.

3. The lathe according to claim 1, wherein the tool post is a turret.

4. The lathe according to claim 3, wherein a difference between a maximum value and a minimal value of the first distances for the plurality of mounting surfaces is larger than a range of distances in the first direction between the holder reference point and the tool nose of an identical tool that is variously attached to the tool holder.

5. The lathe according to claim 4, wherein a range of positions of the holder reference point in the first direction with the tool holder variously mounted on an identical mounting surface is larger than the range of the distances in the first direction between the holder reference point and the tool nose of the identical tool that is variously is attached to the tool holder.

6. The lathe according to claim 3,
wherein the tool post is rotatable about a rotation axis passing through the tool post origin, and
wherein the first direction is a direction perpendicular to the rotation axis or a direction parallel to the rotation axis.

7. The lathe according to claim 6, further comprising a workpiece holder configured to hold a workpiece rotatably about a workpiece rotation axis parallel to the rotation axis, wherein the first direction is a direction perpendicular to the rotation axis and the workpiece rotation axis.

8. The lathe according to claim 1, wherein the mounting surfaces are provided on a substantially identical plane.

9. The lathe according to claim 8, wherein the first direction is a normal direction of the identical plane or a direction perpendicular to the normal direction.

10. The lathe according to claim 1,
wherein the memory stores fourth distances in a second direction orthogonal to the first direction between the tool post origin and the holder reference point of the tool holder mounted on mounting surfaces, respectively, when the mounted surface is adjusted to the indexing position, and
wherein the operations further comprise
obtaining, from the storage, a fifth distance in the second direction between the holder reference point and the tool nose of the attached tool with the mounted surface being adjusted to the indexing position, the storage storing third correlation between the identifiers of the candidate tools and the fifth distances in the second direction between the holder reference point and the tool noses of the candidate tools, respectively; and
estimating, based on the fourth distances, the mounted surface, and the fifth distance that has been obtained, a sixth distance in the second direction between the tool post origin and the tool nose of the attached tool to control the actuator based on the sixth distance.

11. The lathe according to claim 1,
wherein the tool has a tool center axis,
wherein the tool holder has a target center axis,
wherein the tool holder includes
one of a guide surface and a guided surface, the guide surface extending along the target center axis in an insertion direction from one of the tool holder and the tool toward another of the tool holder and the tool to gradually approach the target center axis along the insertion direction so that the tool center axis substantially share a common axis with the target center axis, the guided surface being configured to be guided by the guide surface,
either at least two surfaces of at least two posture adjustment surfaces and at least two contact surfaces, the at least two posture adjustment surfaces crossing a circumferential direction centered around the common axis, the at least two contact surfaces being configured to abut against the at least two posture adjustment surfaces, respectively, and
one of an engagement jaw and an engagement groove, the engagement jaw being configured to regulate or deregulate movement of the tool in the insertion direction and a withdrawal direction opposite to the insertion direction, the engagement groove being provided around the common axis to be engageable with the engagement jaw, and
wherein the tool includes
another of the guide surface and the guided surface,
remaining at least two surfaces of the at least two posture adjustment surfaces and the at least two contact surfaces, the remaining at least two surfaces being other than the either at least two surfaces, and
another of the engagement jaw and the engagement groove.

12. The lathe according to claim 1,
wherein a measurement tool having a measurement target is attachable to the tool holder, and
wherein the first distance is a value obtained from a measurement value of a distance in the first direction between the measurement target and the tool post origin in a state in which the mounted surface is adjusted to the indexing position and the measurement tool is attached to the tool holder, and obtained based on a seventh distance in the first direction between the holder reference point and the measurement target with the measurement tool being attached to the tool holder when the mounted surface is adjusted to the indexing position.

13. The lathe according to claim 1,
wherein the memory is configured to store second correlation between an identifier of the mounted surface, the first distance, and the identifier of the attached tool, and
wherein the processor is configured to:
obtain an identifier of a mounting surface adjusted to the indexing position; and
determine the first distance and the identifier of the attached tool based on the identifier of the mounting surface that has been obtained.

14. A lathe machining system comprising:
the lathe according to claim 13;
a tool presetter configured to:
obtain an identifier of the tool; and
measure the second distance for a measured tool identified by the identifier of the tool that has been obtained in a state in which the measured tool is removed from the tool holder;
a network via which the processor is configured to communicate with the tool presetter; and
the storage connected to the network,
wherein the storage is configured to store the first correlation such that the first correlation correlates the identifier of the measured tool with data indicating the second distance that has been measured, and
wherein the processor is configured to obtain the second distance corresponding to the identifier of the measured tool that is identical to the identifier of the attached tool.

15. A method of estimating a nose position in a lathe, the method comprising:
preparing a tool holder which has a holder reference point and to which a tool having a tool nose is attachable;
preparing a tool post having a tool post origin and having a plurality of mounting surfaces;
mounting the tool holder on a mounted surface among the plurality of mounting surfaces;
attaching, to the tool holder, a measurement tool having a measurement target;
moving the tool post to adjust the mounted surface to an indexing position;
measuring a distance in a first direction between the measurement target and the tool post origin;
obtaining a seventh distance in the first direction between the holder reference point and the measurement target with the measurement tool being attached to the tool holder, the mounted surface being adjusted to the indexing position;
based on the measured distance and the seventh distance, obtaining a first distance in the first direction between the tool post origin and the holder reference point to store the first distance;
obtaining an identifier of a measured tool;
measuring a second distance in the first direction between the holder reference point and the tool nose of the measured tool when the measured tool is attached to the tool holder and the mounted surface is adjusted to the indexing position;
storing first correlation that correlates the identifier of the measured tool with the second distance;
attaching an attached tool to the tool holder to adjust the mounted surface to the indexing position;
obtaining an identifier of the attached tool; and
obtaining the second distance corresponding to the identifier of the measured tool that is identical to the identifier of the attached tool, and estimating a third distance in the first direction between the tool post origin and the tool nose of the attached tool based on the second distance that has been obtained and the first distance.
